(19) United States
(12) Patent Application Publication
(10) Pub. No.: US 2026/0273952 A1
(43) Pub. Date: Sep. 17, 2026

(54) SYSTEMS, METHODS, AND KITS FOR USE WITH INTERMEDIATE TRANSFER MEMBERS

(71) Applicant: LANDA CORPORATION LTD., Rehovot (IL)

(72) Inventors: Einat TIROSH, Ramat Gan (IL); Eran ARONOVITCH, Ness Ziona (IL); Parisa SHRAGA, Yavne (IL); Yael NEFESH KARUTZERU, Rosh Haayin (IL); Helena CHECHIK, Rehovot (IL)

(21) Appl. No.: 19/165,131

(22) PCT Filed: Apr. 3, 2023
(86) PCT No.: PCT/IB2023/053369

§ 371 Date: Sep. 14, 2025

(51) Int. Cl. B41J 2/205; B41J 2/01; B41M 5/025; C09D 11/324; C09D 11/54

(52) U.S. Cl. CPC B41J 2/2054; B41M 5/0256; C09D 11/54; B41J 2002/012; C09D 11/324

(57) ABSTRACT

Kits, methods, and systems for use with, or including, an intermediate transfer member (ITM) of a printing system. The kits, methods, and systems include a liquid hydrophilic treatment formulation, whose dry form is a non-cohesive form of a solid or semisolid material sweated with a non-volatile liquid oil. The kits methods and systems further include a liquid surfactant additive disposed in a second container, separately from the liquid hydrophobic treatment formulation. The liquid hydrophilic treatment formulation is devoid of the liquid surfactant additive.

### TECHNOLOGICAL FIELD

The present disclosure relates to indirect printing processes and systems, and more particularly to treatment formulations suitable for the treatment of intermediate transfer members utilized in such processes and systems. Specifically, the present disclosure relates to systems, methods, and kits for use with intermediate transfer members to control or configure the resolution of an image being printed.

### BACKGROUND ART

The following patent publications [1] to the Applicant provide potentially relevant background material, and are all incorporated herein by reference in their entirety:
[1] WO/2013/132339 (publication of PCT/IB2013/000757);
[2] WO/2015/036960 (publication of PCT/IB2014/064444);
[3] WO/2015/036864 (publication of PCT/IB2014/002366);
[4] WO/2019/111223 (publication of PCT/IB2018/059761);
[5] WO/2020/141465 (publication of PCT/IB2020/050001);
[6] WO 2017/208246 (publication of PCT/IL2017/050616);
[7] WO/2020/003088 (publication of PCT/IB2019/055288);
[8] WO 2017/208152 (publication of PCT/IB2017/053177);
[9] WO 2013/132418 (publication of PCT/IB2013/051716);
[10] WO 2013/132439 (publication of PCT/IB2013/51755);
[11] WO 2015/036865 (publication of PCT/IB2014/02395);
[12] WO 2019/012456 (publication of PCT/IB2018/055126);
[13] WO 2020/136517 (publication of PCT/IB2019/061081);
[14] WO 2013/132420 (publication of PCT/IB2013/051718);
[15] WO 2015/036906 (publication of PCT/IB2014/064277);
[16] WO 2021/137063 (publication of PCT/IB2020/061673);
[17] U.S. Provisional Application No. 63/362,971; and
[18] WO 2013/132345 (publication of PCT/IB2013/000840).

Acknowledgement of the above references herein is not to be inferred as meaning that these are in any way relevant to the patentability of the presently disclosed subject matter.

### SUMMARY OF THE INVENTION

The inventors of the present invention have developed kits, methods, and systems for use with an intermediate transfer member (ITM) of indirect printing systems, to assist in controlling the resolution, or dot size, of a printed image.

As will be detailed herein below, the kits of the present invention include a liquid hydrophobic treatment formulation and a liquid surfactant additive. The liquid hydrophobic treatment formulations are substantially devoid of cohesive agents and/or cohesive inducing agents such as water-soluble polymeric binders, and are devoid of the liquid surfactant additive. The inventors have surprisingly found that mixing a small quantity of the additive into the liquid hydrophobic treatment formulation and applying it to an ITM, affects the dot size formed when jetting ink onto the ITM and improves the resolution of the printed matter relative to when no additive is used.

The inventors have surprisingly found that, when the ITM is pretreated with a mixture of the hydrophobic treatment formulation and liquid surfactant additive, within a range of small quantities of the additive, the size of dots formed from ink droplets applied to the ITM is inversely proportionate to the quantity of additive—the more additive used, the smaller the dot size. Consequently, the inventors have found that the diameter of a dot printed onto the ITM by depositing an ink droplet of a given volume onto the ITM is controllable, or configurable, by modification or control of the quantity of additive in the treatment mixture used to pre-treat the ITM.

Kits of the present invention include the liquid hydrophilic treatment formulation and the liquid surfactant additive, disposed in separate containers or otherwise separated from each other. The liquid hydrophilic treatment formulation in the kit is devoid of the liquid surfactant additive, and is only exposed to the liquid surfactant additive when forming the mixture between the two components, at a desired ratio to obtain a desired print resolution, or printed dot diameter. The mixture of the liquid hydrophilic treatment formulation and the liquid surfactant additive retains some properties of the liquid hydrophilic treatment formulation, such as solubility, density, clarity, and color. The mixture is different from the liquid hydrophilic treatment formulation in some other properties, such as the surface tension, surface energy, and wetting.

In the present invention, a release surface of an intermediate transfer member is pre-treated (e.g., coated) with a mixture formed of the components of the kits according to the present invention before deposition of an ink image thereto. The mixture is applied to a surface of an ITM to form thereon a thin wet treatment layer which is subjected to a drying process on the ITM release surface to leave a thin, at least partially dried non-cohesive treatment layer on the ITM release surface. Once the at least partially dry thin non-cohesive treatment layer is formed on the ITM, droplets of an aqueous ink are deposited (e.g. by ink-jetting) onto said layer to form an ink image thereon. It is noted that the ink droplets may be continuous or none-continuous. It is further noted that the ink droplets may cover the whole area of the treatment layer or part of the area thereof (the latter case results with regions on said layer with no ink deposited thereon). The formed ink-image is then subjected to a drying process to leave an ink residue on the treatment layer. The dried ink-image is then transferred from the ITM surface to a final printed substrate (e.g. foil-based, paper-based or plastic-based).

In some aspects of the present invention, the ratio of the liquid hydrophilic treatment formulation and of the liquid surfactant additive is manually or automatically selected based on a required resolution of the image to be printed. In some aspects of the present invention, the mixture may be automatically formed, for example within a station of the indirect printing system, for example in accordance with the selected ratio. Thus, the present invention provides in a first one of its aspects a kit for use with an intermediate transfer member (ITM) of a printing system, the kit comprising:
a) a liquid hydrophilic treatment formulation disposed in a first container, wherein a dry form of the hydrophilic treatment formulation is a non-cohesive form of a solid or semisolid material sweated with a non-volatile liquid oil;
b) a liquid surfactant additive disposed in a second container, such that the liquid hydrophobic treatment formulation is separate from the liquid surfactant additive,
wherein the liquid hydrophilic treatment formulation is devoid of the liquid surfactant additive,
wherein application of an aqueous ink onto an at least partially dry form of the hydrophilic treatment formulation applied to the ITM forms ink dots having a first diameter,
wherein application of the aqueous ink onto at least partially dry form of a mixture of a first quantity of the hydrophilic treatment formulation and a second quantity of the surfactant additive, the second quantity being smaller than the first quantity, the mixture applied to the ITM, forms ink dots having a second diameter, smaller than the first diameter, and
wherein the second diameter is configurable by modification of a ratio between the first quantity of the liquid hydrophilic treatment formulation in the mixture and the second quantity of the liquid surfactant additive in the mixture.

The present invention provides, in a second one of its aspects, a kit for use with an intermediate transfer member (ITM) of a printing system, the kit comprising:
a) a liquid hydrophilic treatment formulation disposed in a first container, wherein a dry form of the hydrophilic treatment formulation is a non-cohesive form of a solid or semisolid material sweated with a non-volatile liquid oil;
b) a liquid surfactant additive disposed in a second container, such that the liquid hydrophobic treatment formulation is separate from the liquid surfactant additive,
wherein the liquid hydrophilic treatment formulation is devoid of the liquid surfactant additive,
wherein a mixture of a first quantity of the hydrophilic treatment formulation and a second quantity of the surfactant additive, retains at least one of the following properties of the liquid hydrophilic treatment formulation in the first container: solubility; clarity; color; reactivity with an aqueous ink used for printing on the ITM of the printing system; ability to be applied to the ITM; drying properties; ability to form an ink film following deposit of aqueous ink onto a layer of the mixture; mechanical properties; and ability to be covered with a coating layer.

The present invention provides in a third one of its aspects a method of indirect printing using the kits of the present invention, the method comprising:
a. providing an intermediate transfer member (ITM) comprising a release layer surface;
b. mixing the first quantity of the hydrophilic treatment formulation with the second quantity of the surfactant additive to form the mixture;
c. applying the mixture onto the release layer surface of the ITM to form thereon a wet treatment layer optionally having a thickness of at most about 5.0 μm;
d. at least partially drying the wet treatment layer to thereby form an at least partially dried non-cohesive sweating treatment layer from the wet treatment layer on the ITM release layer surface, the at least partially dried non-cohesive sweating treatment layer optionally having a thickness of at least about 20 nm and at most about 500 nm;
e. depositing droplets of an aqueous ink, onto at least a region of the at least partially dried non-cohesive sweating treatment layer, to form an ink image on the ITM release layer surface;
f. drying the ink image to leave an ink-image residue on the ITM release layer surface; and
g. transferring the ink-image residue onto a printing substrate by pressured contact between the ITM and the printing substrate.

The present invention provides in a fourth one of its aspects a system for indirect printing using a kit of the present invention, the system comprising:
a. an intermediate transfer member (ITM) comprising a release layer surface;
b. a mixture of the first quantity of the hydrophilic treatment formulation and the second quantity of the surfactant additive;
c. a treatment station for applying the mixture to the release layer surface of the ITM to form thereon a wet treatment layer optionally having a thickness of at most 5.0 μm;
d. means for subjecting the wet treatment layer to a drying process to form an at least partially dried non-cohesive sweating treatment layer from the wet treatment layer on the ITM release layer surface, the at least partially dried non-cohesive sweating treatment layer optionally having a thickness of at least about 20 nm and at most about 500 nm;
e. at least one ink jet nozzle positioned proximate the intermediate transfer member and configured for jetting aqueous ink droplets, onto at least a region of the at least partially dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

The present invention provides in a fifth one of its aspects a printed article comprising:
(i) a substrate;
(ii) one or more dry ink dots fixedly adhered to at least a region of a surface of the substrate,
wherein the one or more dry ink dots comprise at least one binder, at least one colorant and one or more of non-volatile ingredients of a kit of the present invention.

The present invention provides in a sixth one of its aspects an intermediate transfer member comprising a release layer surface, wherein the surface is substantially covered with a dry non-cohesive sweating layer comprising one or more of the non-volatile ingredients of the hydrophilic treatment formulation and the surfactant additive of a kit of the present invention, and optionally wherein the thickness of the dry non-cohesive sweating layer being of at least about 20 nm and at most about 500 nm.

The present invention provides in a seventh one of its aspects an intermediate transfer member comprising a release layer surface, wherein the surface is substantially covered with a mixture of the first quantity of the hydrophilic treatment formulation and the second quantity of the surfactant additive of a kit of the present invention.

The present invention provides in an eighth one of its aspects an intermediate transfer member comprising a release layer surface, wherein the surface is substantially covered with a mixture of the first quantity of the hydrophilic treatment formulation and the second quantity of the surfactant additive of a kit of the present invention, and wherein when the intermediate transfer member is at a temperature being of between about 90° C. to about 130° C., a dried non-cohesive sweating treatment layer is formed thereon, optionally wherein the thickness of the dry non-cohesive sweating layer being of at least about 20 nm and at most about 500 nm.

The present invention provides in a ninth one of its aspects a printing system comprising:
(a) an intermediate transfer member (ITM) comprising an endless belt;
(b) a mixing element adapted to form a mixture from a first quantity of a liquid hydrophilic treatment formulation and a second quantity of a liquid surfactant additive, the second quantity being at most 2% of the first quantity;
(c) a treatment station for applying the mixture to the surface of the ITM to form thereon a wet treatment layer;
(d) an image forming station at which droplets of an ink are applied to an at least partially dried layer, formed on the ITM of the wet treatment layer, to form an ink image;
(e) a drying station for drying the ink image to leave an ink residue film; and
(f) an impression station at which the residue film is transferred to a sheet or web substrate sheet.

The present invention provides in a tenth one of its aspects a printing system comprising:
(a) an intermediate transfer member (ITM) comprising an endless belt;
(b) at least one nozzle disposed adjacent the ITM for applying a mixture to the surface of the ITM to form thereon a wet treatment layer, the mixture comprising a first quantity of a liquid hydrophilic treatment formulation and a second quantity of a liquid surfactant additive, the second quantity being at most 2% of the first quantity;
(c) an image forming station at which droplets of an ink are applied to an at least partially dried form of the mixture layer on the ITM to form an ink image;
(d) a drying station for drying the ink image to leave an ink residue film; and
(e) an impression station at which the residue film is transferred to a sheet or web substrate sheet.

The present invention provides in an eleventh sixth one of its aspects a method comprising:
(a) obtaining a kit comprising a liquid hydrophilic treatment formulation and a liquid surfactant additive disposed, separate from each other;
(b) at a first time, forming a first mixture by mixing a given volume of the liquid hydrophilic treatment formulation with a first volume of the liquid surfactant additive;
(c) at the first time, applying the first mixture onto the surface of an intermediate transfer member (ITM) of a printing system;
(d) at the first time, printing a first image onto the ITM having the first mixture applied thereon, by jetting droplets of an aqueous ink onto the ITM from at least one nozzle, the droplets having a given volume, to obtain first printed dots having a first diameter;
(e) at a second time, forming a second mixture by mixing the given volume of the liquid hydrophilic treatment formulation with a second volume of the liquid surfactant additive, the second volume being larger than the first volume;
(f) at the second time, applying the second mixture onto the surface of the ITM of the printing system;
(g) at the second time, printing a second image onto the ITM having the second mixture applied thereon, by jetting droplets of the aqueous ink onto the ITM from the at least one nozzle, the droplets having the given volume, to obtain second printed dots having a second diameter, smaller than the first diameter.

The present invention provides in a twelfth one of its aspects a system comprising:
(a) a printing system comprising:
   i) an intermediate transfer member (ITM) comprising an endless belt;
   ii) a treatment station for applying a mixture, including a given quantity of a liquid hydrophilic treatment formulation and a second quantity of a liquid surfactant additive, to the surface of the ITM to form thereon a wet treatment layer;
   iii) an image forming station at which droplets of an ink are applied to an at least partially dried layer, formed on the ITM of the wet treatment layer, to form an ink image;
   iv) a drying station for drying the ink image to leave an ink residue film; and
   v) an impression station at which the residue film is transferred to a sheet or web substrate sheet;
(b) a first kit including a first container holding the given quantity of the liquid hydrophilic treatment formulation and a second container holding a first volume of the liquid surfactant additive, the first volume usable as the second quantity when printing a first printing job on the printing system; and
(c) a second kit including a third container holding the given quantity of the liquid hydrophilic treatment formulation and a fourth container holding a second volume of the liquid surfactant additive, usable as the second quantity when printing a second printing job on the printing system, the second volume being greater than the first volume.

The present invention provides in a thirteenth one of its aspects a method comprising:
(a) obtaining a kit comprising a liquid hydrophilic treatment formulation and a liquid surfactant additive, separate from each other;
(b) applying onto a surface of a first intermediate transfer member (ITM) of a first printing system a first mixture including a given volume of the liquid hydrophilic treatment formulation and a first volume of the liquid surfactant additive;
(c) printing a first image onto the first ITM having the first mixture applied thereon, by jetting droplets of an aqueous ink onto the first ITM from at least one nozzle, the droplets having a given volume, to first obtain printed dots having a first diameter;
(d) applying onto a surface of a second intermediate transfer member (ITM) of a second printing system a second mixture including the given volume of the liquid hydrophilic treatment formulation and a second volume of the liquid surfactant additive, the second volume being larger than the first volume; and
(e) printing a second image onto the second ITM having the second mixture applied thereon, by jetting droplets of an aqueous ink onto the second ITM from at least one nozzle, the droplets having the given volume, to obtain second printed dots having a second diameter, smaller than the first diameter,
   wherein the first printing system and the second printing system are printing systems of the same type, and
   wherein the first ITM and the second ITM are ITMs of the same type.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic side view illustration of a printing system (e.g., digital printing system), according to some embodiments of the invention.

FIG. 2 is a schematic side view illustration of an arrangement including multiple printing systems of FIG. 1, according to some embodiments of the invention.

FIG. 3 is a flow chart of an indirect printing process according to some embodiments of the invention, implemented, for example, using the printing system of FIG. 1.

FIG. 4 is a flow chart of an indirect printing process according to some embodiments of the invention, implemented, for example, using the printing system of FIG. 1.

FIG. 5 is a flow chart of an indirect printing process according to some embodiments of the invention, implemented, for example, using the system of FIG. 2.

FIG. 6 displays printed images utilizing black ink and the resolution of the same printed images when using different quantities of a liquid surfactant additive with a given quantity of a first liquid hydrophilic treatment formulation, according to some embodiments of the invention.

FIG. 7 displays printed images utilizing black ink and the dot size measured when using different quantities of a liquid surfactant additive with a given quantity of a first liquid hydrophilic treatment formulation, according to some embodiments of the invention.

FIG. 8 displays the % additive vs dot size of black ink as observed with mixtures including different quantities of a liquid surfactant additive with a given quantity of a first liquid hydrophilic treatment formulation, according to some embodiments of the invention.

FIG. 9 displays printed images utilizing black ink and the resolution of the same printed images when using different quantities of a liquid surfactant additive with a given quantity of a first liquid hydrophilic treatment formulation, according to some embodiments of the invention.

FIG. 10 displays printed images utilizing black ink and the dot size measured when using different quantities of a liquid surfactant additive with a given quantity of a first liquid hydrophilic treatment formulation, according to some embodiments of the invention.

FIG. 11 displays the % additive vs dot size of black ink as observed with mixtures including different quantities of a liquid surfactant additive with a given quantity of a first liquid hydrophilic treatment formulation, according to some embodiments of the invention.

### DETAILED DESCRIPTION OF THE INVENTION

Various embodiments will be detailed herein in connection with the disclosed invention. It is noted that one or more of these embodiments may be applicable to one or more aspects of the invention disclosed herein above and below. It is further noted that one or more embodiments which are detailed in connection with the treatment formulations of the invention may also be applicable to the other aspects of the invention as detailed herein e.g., methods, systems, processes, uses, printed articles and ITMs, and vice-versa.

### A. System Description

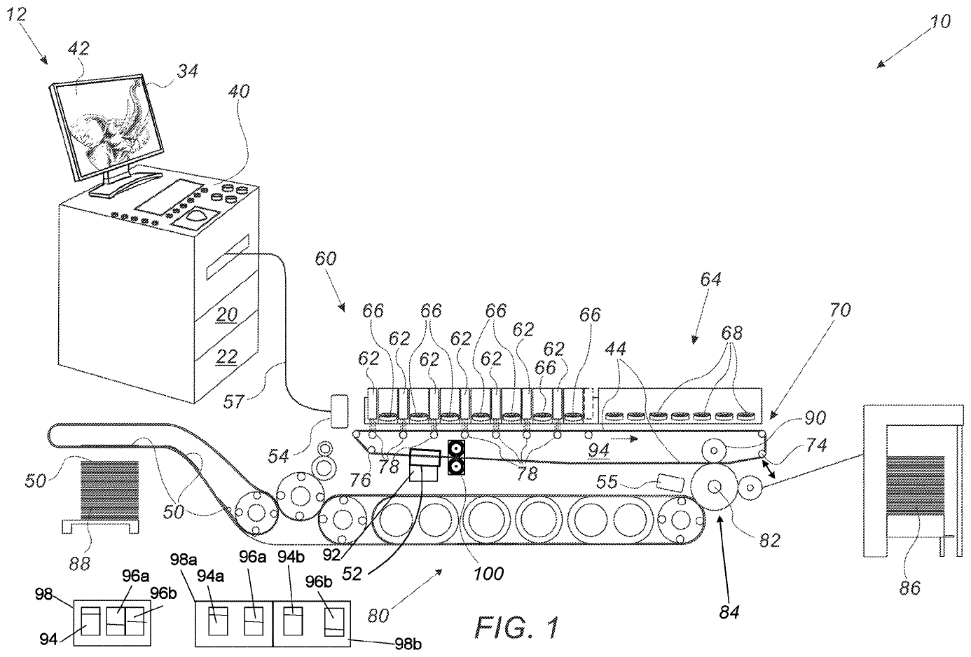

Reference is now made to FIG. 1, which is a schematic side view illustration of a digital printing system 10, in accordance with some embodiments of the present invention. In some embodiments, system 10 comprises a rolling flexible blanket 44 that cycles through an image forming station 60, a drying station 64, an impression station 84, and a blanket treatment station 52. In some optional embodiments, system 10 may optionally further include an ITM cleaning station (ICLS) 100.

In an operative mode, image forming station 60 is configured to form a mirror ink image, also referred to herein as “an ink image” (not shown) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44.

In some embodiments, during installation blanket 44 may be adhered edge to edge to form a continuous blanket loop (not shown). An example of a method and a system for the installation of the seam is described in detail in PCT Patent Publication No. WO 2019/012456, whose disclosure is incorporated herein by reference.

In some embodiments, image forming station 60 typically comprises multiple print bars 62, each mounted (e.g., using a slider) on a frame (not shown) positioned at a fixed height above the surface of the upper run of blanket 44. In some embodiments, each print bar 62 comprises a strip of print heads as wide as the printing area on blanket 44 and comprises individually controllable print nozzles.

In some embodiments, image forming station 60 may comprise any suitable number of bars 62, each bar 62 may contain a printing fluid, such as an aqueous ink of a different color. The ink typically has visible colors, such as but not limited to cyan, magenta, yellow and black. In the example of FIG. 1, image forming station 60 comprises seven print bars 62, but may comprise, for example, four print bars 62 having any selected colors such as cyan, magenta, yellow and black.

In some embodiments, the print heads are configured to jet ink droplets of the different colors onto the surface of blanket 44 so as to form the ink image (not shown) on the surface of blanket 44. In some embodiments, the print heads are configured to jet ink droplets having a given volume.

In some embodiments, different print bars 62 are spaced from one another along the movement axis, also referred to herein as moving direction of blanket 44, represented by an arrow 94. In this configuration, accurate spacing between bars 62, and synchronization between directing the droplets of the ink of each bar 62 and moving blanket 44 are essential for enabling correct placement of the image pattern.

In some embodiments, system 10 comprises heaters, such as hot gas or air blowers 66 and/or infrared (IR) heaters or and other suitable type of heaters adapted for the printing application. In the example of FIG. 1, air blowers 66 are positioned in between print bars 62, and are configured to partially dry the ink droplets deposited on the surface of blanket 44. This hot air flow between the print bars may assist, for example, in reducing condensation at the surface of the print heads and/or in handling satellites (e.g., residues or small droplets distributed around the main ink droplet), and/or in preventing blockage of the inkjet nozzles of the print heads, and/or in preventing the droplets of different color inks on blanket 44 from undesirably merging into one another. In some embodiments, system 10 comprises drying station 64, configured to blow hot air (or another gas) onto the surface of blanket 44. In some embodiments, drying station comprises air blowers 68 or any other suitable drying apparatus.

In drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered tacky ink film.

In some embodiments, system 10 comprises a blanket module 70 comprising a rolling ITM, such as a blanket 44. In some embodiments, blanket module 70 comprises one or more rollers 78, wherein at least one of rollers 78 comprises an encoder (not shown), which is configured to record the position of blanket 44, so as to control the position of a section of blanket 44 relative to a respective print bar 62. In some embodiments, the encoder of roller 78 typically comprises a rotary encoder configured to produce rotary-based position signals indicative of an angular displacement of the respective roller. Note that in the context of the present invention and in the claims, the terms “indicative of” and “indication” are used interchangeably.

Additionally or alternatively, blanket 44 may comprise an integrated encoder (not shown) for controlling the operation of various modules of system 10. One implementation of the integrated encoder is described in detail, for example, in PCT Patent Application Publication No. WO 2020/003088, whose disclosure is incorporated herein by reference.

In some embodiments, blanket 44 is guided over rollers 76 and 78 and a powered tensioning roller, also referred to herein as a dancer assembly 74. Dancer assembly 74 is configured to control the length of slack in blanket 44 and its movement is schematically represented by a double-sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produce by the tension sensors, so as to monitor the tension applied to blanket 44 and to control the operation of dancer assembly 74.

In impression station 84, also referred to herein as an image transfer station, blanket 44 passes between an impression cylinder 82 and a pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose computer, with suitable front end and interface circuits for interfacing with controllers of dancer assembly 74 and with a controller 54, via a cable 57, and for receiving signals therefrom. In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a liquid treatment mixture, for example according to embodiments of the present invention, to the outer surface of blanket 44, and/or cleaning the outer surface of blanket 44. At blanket treatment station 52, the temperature of blanket 44 can be reduced to a desired value before blanket 44 enters image forming station 60. The treatment may be carried out by passing blanket 44 over one or more rollers or blades configured for applying cooling and/or cleaning and/or liquid treatment mixture on the outer surface of the blanket.

In some embodiments, the layer of the liquid mixture applied to the outer surface of blanket 44, or to a release layer surface thereof, has a thickness of at most 5.0 μm.

In some embodiments, blanket treatment station 52 may be positioned adjacent to image forming station 60, in addition to or instead of the position of blanket treatment station 52 shown in FIG. 1.

In some embodiments, the blanket treatment station may comprise one or more bars, adjacent to print bars 62, and the liquid treatment mixture is applied to blanket 44 by jetting, prior to the ink jetting at the image forming station.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet, station 52 may be mounted adjacent to blanket 44 at any other or additional one or more suitable locations between impression station 84 and image forming station 60. As described above, station 52 may additionally or alternatively comprise a bar adjacent to image forming station 60.

In some embodiments, the wet treatment layer formed of the liquid treatment mixture is at least partially dried, prior to ink droplets being deposited thereon at the image forming station. In some embodiments, the at least partially dried treatment liquid forms an at least partially dried non-cohesive sweating treatment layer on the ITM release layer surface. In some embodiments, the at least partially dried non-cohesive sweating treatment layer has a thickness in the range of 20 nm to 500 nm.

In some embodiments, the ink droplets jetted onto blanket 44 at image forming station 60 are deposited onto at least a region of the non-cohesive sweating treatment layer disposed on the ITM. In such embodiments, drying of the ink droplets at drying station 64 dries the ink and the non-cohesive sweating treatment layer to form the ink image residue on the ITM, which is to be impressed onto a printing substrate at impression station 84.

In some embodiments, printing system 10 may further include a mixing element 92 adapted to form the liquid treatment mixture used in treatment station 52. For example, mixing element 92 may optionally provide the mixture into a reservoir (not shown) associated with treatment station 52. However, it is not necessary for the mixing element 92 to be physically connected to the reservoir or to treatment station 52. In some embodiments, the liquid treatment mixture may be formed remotely from treatment station 52, and even remotely from system 10, and then brought to the site of system 10 and provided to treatment station 52 for use therein.

In some embodiments, mixing element 92 forms a mixture of a first quantity of a liquid hydrophilic treatment formulation (discussed hereinbelow) disposed in a first container 94, and a second quantity of a liquid surfactant additive (discussed hereinbelow) disposed in a second container 96. In some embodiments, the first container 94 and the second container 96 form part of a kit 98, discussed in further detail hereinbelow. As explained in further detail hereinbelow, the second quantity being at most 2% by weight or by volume of the first quantity.

In some embodiments, mixing element 92 is an automatic mixing element, functionally associated with first container 94 and with second container 96.

In some embodiments, controller 20 is configured to provide instructions to mixing element 92 to create a mixture having a specific volume or weight ratio. For example, controller 20 may instruct mixing element 92 to use a given volume of liquid hydrophilic treatment formulation from first container 94 and a first volume of liquid surfactant additive from second container 96 to form a first mixture for a first print job. Controller 20 may instruct mixing element 92 to use the same given volume of liquid hydrophilic treatment formulation from first container 94 and a second volume of liquid surfactant additive from second container 96 to form a second mixture for a second print job, the second volume being distinct from the first volume.

In some embodiments, the first volume and/or the second volume may be automatically selected by controller 20, based on required resolutions for each of, or both of, the first print job and second print job. For example, if the first print job requires a higher resolution than the second print job, the first quantity of the liquid surfactant additive may be larger than the second quantity of the liquid surfactant additive, as explained and shown hereinbelow. For example, controller 20 may receive, e.g. from a user, a print job to be printed, and may select a corresponding quantity of the liquid surfactant additive to be used based on the required resolution of the received print job.

In some embodiments, a first kit 98a may include the given volume of the liquid hydrophilic treatment formulation in a first container 94a and the first volume of the liquid surfactant additive in a second container 96a, and a second kit 98b, separate from first kit 98a, may include the given volume of the liquid hydrophilic treatment formulation in a first container 94b and the second volume of the liquid surfactant additive in a second container 96b. In some such embodiments, mixing element 92 may be configured to mix the entire contents of each kit for forming each of the first and second mixtures, respectively.

In some other embodiments, a single kit 98 may include the given volume of the liquid hydrophilic treatment formulation in the first container 94, and multiple second containers 96a, 96b, etc. each including a different volume of the liquid surfactant additive. In some such embodiments, mixing element 92 may be configured to mix the contents of first container 94 with the contents of one of second containers 96a, 96b etc for forming the first mixture and/or the second mixture. In the example of FIG. 1, impression cylinder 82 impresses the ink image onto the target flexible substrate, such as an individual sheet 50, conveyed by substrate transport module 80 from an input stack 86 to an output stack 88 via impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders so as to permit one or more duplex printing. The configuration of two impression cylinders also enables conducting single sided prints at twice the speed of printing double sided prints. In addition, mixed lots of single- and double-sided prints can also be printed. In alternative embodiments, a different configuration of module 80 may be used for printing on a continuous web substrate. Detailed descriptions and various configurations of duplex printing systems and of systems for printing on continuous web substrates are provided, for example, in PCT International Publications WO 2013/132420, and WO 2013/132424 whose disclosures are all incorporated herein by reference.

As briefly described above, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by compressible blanket (not shown), of pressure cylinder 90 against sheet 50 (or other suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets, thereby placement of the ink image, by forming station 60, on the surface of blanket 44.

In some embodiments, impression cylinder 82 is periodically engaged to and disengaged from blanket 44 to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

As described above, the ink image typically comprises a printing fluid, such as an aqueous ink having multiple colors of ink, and the aforementioned at least partially dried layer of the treatment mixture, applied to blanket 44 using blanket treatment station 52. In some cases, after transferring the ink image from blanket 44 to sheet 50, residues may remain on blanket 44 and may cause, inter-alia, scratches on blanket 44 and contamination of system 10.

In some embodiments, system 10 may optionally comprise ITM cleaning station (ICLS) 100, which may be mounted between impression station 84 and blanket treatment station 52. In some embodiments, ICLS 100 comprises one or more pairs of rotatable elements, in the present example one pair of rollers shown schematically engaged with one another. When engaged, the rollers are configured to remove from blanket 44, the aforementioned residues. An exemplary ICLS is described in PCT Patent Application Publication No. WO 2021/137063, which is incorporated by reference as if fully set forth herein.

Note that the components of both ICLS 100 and blanket treatment station 52 are, or can be, positioned at both sides of blanket 44, as illustrated in FIG. 1, i.e. similarly for example to the components of the transfer station.

In some embodiments, system 10 comprises an image quality control station 55, also referred to herein as an automatic quality management (AQM) system, which serves as a closed loop inspection system integrated in system 10. In some embodiments, station 55 may be positioned adjacent to impression cylinder 82, as shown in FIG. 1, or at any other suitable location in system 10.

In some embodiments, station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In some embodiments, station 55 may comprise a spectrophotometer (not shown) configured to monitor the quality of the ink printed on sheet 50.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, color-to-color (C2C) registration, printed geometry, image uniformity, profile and linearity of colors, and functionality of the print nozzles. In some embodiments, processor 20 is configured to automatically detect geometrical distortions or other errors in one or more of the aforementioned attributes. For example, processor 20 is configured to compare between a design version (also referred to herein as a “master” or a “source image” of a given digital image and a digital image of the printed version of the given image, which is acquired by the camera.

In other embodiments, processor 20 may apply any suitable type image processing software, e.g., to a test pattern, for detecting distortions indicative of the aforementioned errors. In some embodiments, processor 20 is configured to analyze the detected distortion in order to apply a corrective action to the malfunctioning module, and/or to feed instructions to another module or station of system 10, so as to compensate for the detected distortion.

In some embodiments, processor 20 is configured to detect, based on signals received from the spectrophotometer of station 55, deviations in the profile and linearity of the printed colors.

In some embodiments, processor 20 is configured to detect, based on the signals acquired by station 55, various types of defects: (i) in the substrate (e.g., blanket 44 and/or sheet 50), such as a scratch, a pin hole, and a broken edge, and (ii) printing-related defects, such as irregular color spots, satellites, and splashes.

In some embodiments, processor 20 is configured to detect these defects by comparing between a section of the printed and a respective reference section of the original design, also referred to herein as a master. Processor 20 is further configured to classify the defects, and, based on the classification and predefined criteria, to reject sheets 50 having defects that are not within the specified predefined criteria.

In some embodiments, the processor of station 55 is configured to decide whether to stop the operation of system 10, for example, in case the defect density is above a specified threshold. The processor of station 55 is further configured to initiate a corrective action in one or more of the modules and stations of system 10, as described above. The corrective action may be carried out on-the-fly (while system 10 continue the printing process), or offline, by stopping the printing operation and fixing the problem in a respective modules and/or station of system 10. In other embodiments, any other processor or controller of system 10 (e.g., processor 20 or controller 54) is configured to start a corrective action or to stop the operation of system 10 in case the defect density is above a specified threshold.

Additionally or alternatively, processor 20 is configured to receive, e.g., from station 55, signals indicative of additional types of defects and problems in the printing process of system 10. Based on these signals processor 20 is configured to automatically estimate the level of pattern placement accuracy and additional types of defects not mentioned above. In other embodiments, any other suitable method for examining the pattern printed on sheets 50 (or on any other substrate described above), can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configurations of system 10 are shown by way of example. Embodiments of the present invention, however, are by no means limited to this specific sort of example system, and the principles described herein may similarly be applied to any other sorts of printing systems.

Non-limiting examples of ink formulations which may be used in the present invention are ink formulations disclosed in patent applications/publications to the Applicant WO 2013/132439 (PCT/IB2013/51755) [10], WO 2015/036865 (PCT/IB2014/02395) [11], WO 2017/208152 (PCT/IB2017/053177) [8], and U.S. Provisional Application No. 63/362,971 [17], the content of each is incorporated herein by reference.

In some embodiments the target substrate (printed substrate) is selected from the group consisting of an uncoated fibrous printing substrate, a commodity coated fibrous printing substrate, and a plastic printing substrate.

In some embodiments the target substrate is a fibrous printing substrate e.g., a paper.

In some embodiments the fibrous printing substrate is a paper selected from the group of papers consisting of bond paper, uncoated offset paper, coated offset paper, copy paper, groundwood paper, coated groundwood paper, freesheet paper, coated freesheet paper, and laser paper.

In some embodiments the printing substrate is a coated or uncoated offset substrate.

In some embodiments the fibrous printing substrate is a commodity-coated printing substrate.

In some embodiments the target substrate is a plastic.

In some embodiments the plastic printing substrate is a plastic selected from the group consisting of biaxially oriented polypropylene (BOPP), anti-static polyester and atactic polypropylene.

Exemplary non limiting substates are uncoated paper 140 gsm and Burgo 130 gsm.

Further non limiting exemplary printing substrates are those which have been disclosed in the patent publication to the Applicant WO 2013/132345 (PCT/IB2013/000840) which content thereof is incorporated herein by reference.

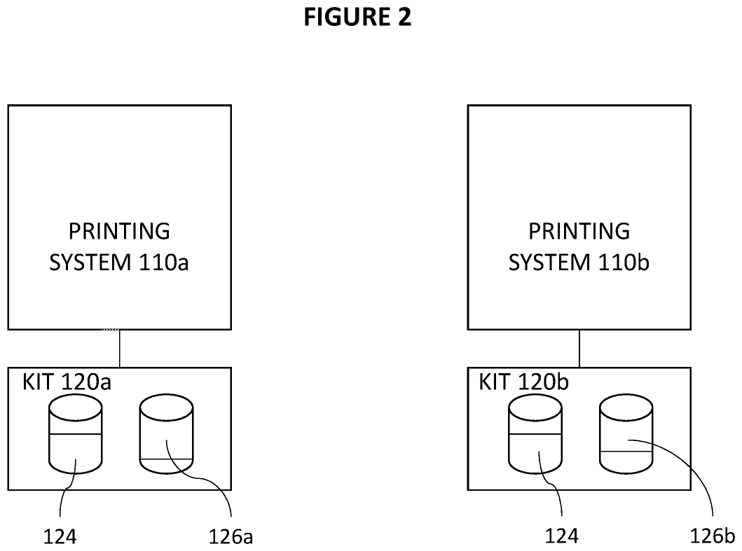

Reference is now made to FIG. 2, which is a schematic side view illustration of an arrangement including multiple printing systems of FIG. 1, according to some embodiments of the invention.

As seen in FIG. 2, there may be a first printing system 110a and a second printing system 110b, both as described hereinabove with respect to FIG. 1. Typically, printing systems 110a and 110b are of the same type, and carry the same type of ITM having the same release layer (for example as described hereinbelow).

Printing systems 110a and 110b are associated with kits 120a and 120b, respectively, both being similar to kit 98 of FIG. 1. Both kits 120a and 120b include a given volume of the liquid hydrophilic treatment formulation in a first container 124 (similar to container 94 of FIG. 1). Kit 120a includes a first volume of the liquid surfactant additive in a second container 126a, and kit 120b includes a second volume of the liquid surfactant additive in a second container 126b, where the second volume is smaller than the first volume.

In use, the mixing element of printing system 110a prints a first printed product using a mixture formed of the components of kit 120a as the liquid treatment mixture, and printing system 110b prints a second printed product using a mixture formed of the components of kit 120b as the liquid treatment mixture. The resolution of the second printed product is smaller than the resolution of the first printed product.

In some embodiments, printing systems 110a and 110b may be used to print the first printed product and the second printed product at different times.

In some embodiments, printing systems 110a and 110b may be used to print the first printed product and the second printed product at the same time.

In some embodiments, printing systems 110a and 110b may be disposed in the same location (e.g. in a single plant or factory).

In some embodiments, printing systems 110a and 110b may be disposed in different locations (e.g. in two plants within a single city, within different cities, or within different states).

### B. Method Description

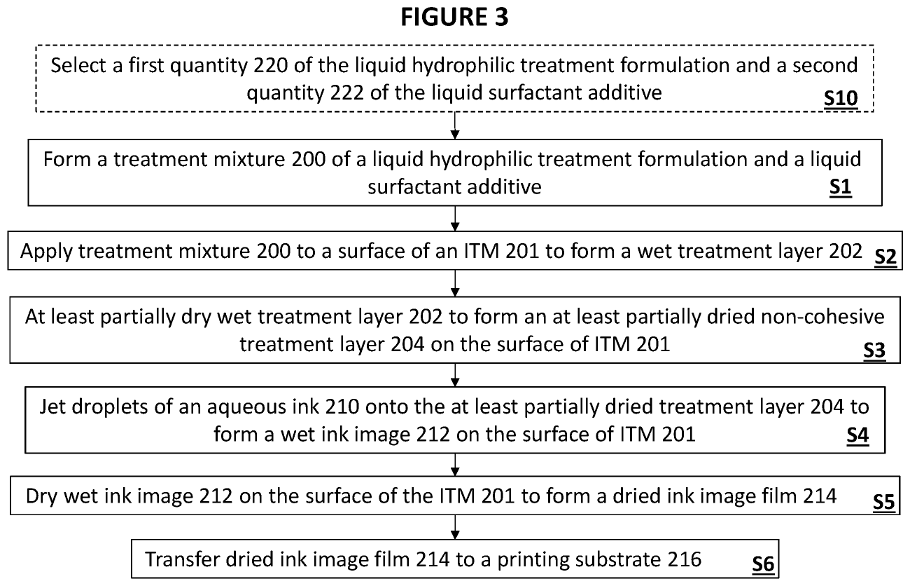

Reference is now made to FIG. 3, which is a flow chart of a printing process according to some embodiments of the invention where an intermediate transfer member (ITM) is pre-treated with a mixture formed of a liquid hydrophilic treatment formulation and a liquid surfactant additive of the present invention before deposition of an ink droplets thereto.

In step S1 of FIG. 3, a treatment mixture 200 is formed of a liquid hydrophilic treatment formulation and a liquid surfactant additive, for example included in respective containers 94 and 96 of kit 98 (FIG. 1).

In step S2, the treatment mixture 200 is applied to a surface of an ITM 201 (e.g. ITM 44 of FIG. 1) to form thereon a wet treatment layer 202. In some embodiments, the wet treatment layer 202 has a thickness of at most 5.0 μm. In some embodiments, the treatment mixture is applied to the ITM by jetting of the treatment mixture onto the ITM from at least one nozzle.

In step S3 of FIG. 3 the wet treatment layer 202 is at least partially dried (e.g., by drying means and/or by the heat of the ITM and/or by the heat of hot air adjacent to the ITM), to form an at least partially dried non-cohesive treatment layer 204 from the wet treatment layer 202 on the surface of the ITM 201. The at least partially dried non-cohesive treatment layer 204 may have a thickness in the range of 20 nm to 500 nm.

In step S4 of FIG. 3, droplets of aqueous ink 210 are ink-jetted onto the at least partially dried non-cohesive treatment layer 204 to form a wet ink image 212 on the surface of the ITM 201. In step S5 of FIG. 3 the ink image 212 is dried on the ITM surface to form a dried ink image film 214. In step S6 of FIG. 3 the dried ink-image film 214 is transferred to a printing substrate 216, typically by pressure contacting.

In some embodiments, the mixing may be automatic, within a mixing element of a printing system.

In some embodiments, the method may further include a step S10, prior to step S1. In step S10 of FIG. 3, a first quantity 220 of the liquid hydrophilic treatment formulation and a second quantity 222 of the liquid surfactant additive are selected, based on a required resolution of the image to be printed. In such embodiments, at mixing step S1, the selected quantities are mixed to form the treatment mixture 200. In some embodiments, the selection at step S10 may be carried out automatically, for example by a processor of a control system controlling the printing press, based on the required resolution for an assigned, or selected, print job.

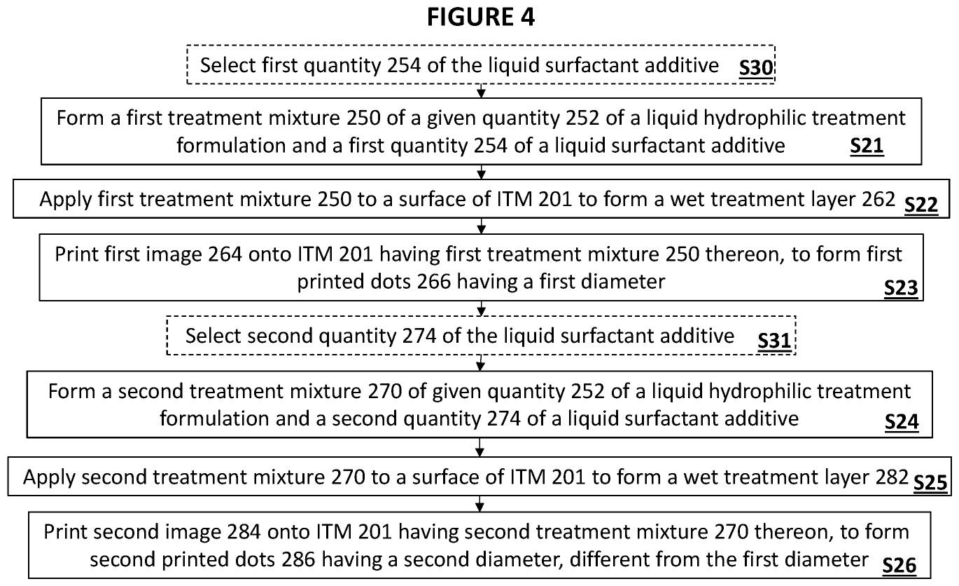

FIG. 4 is a flow chart of a printing process according to some embodiments of the invention where an intermediate transfer member (ITM) is pre-treated with a mixture formed of a liquid hydrophilic treatment formulation and a liquid surfactant additive of the present invention before deposition of an ink droplets thereto.

In step S21 of FIG. 4, a first treatment mixture 250 is formed of a given quantity 252 of a liquid hydrophilic treatment formulation and a first quantity 254 of a liquid surfactant additive. For example, the liquid hydrophilic treatment formulation and the liquid surfactant additive may be included in respective containers 94 and 96a of kit 98a (FIG. 1).

In step S22, the first treatment mixture 250 is applied to a surface of an ITM 201 (e.g. ITM 44 of FIG. 1) to form thereon a wet treatment layer 262. In some embodiments, the wet treatment layer 262 has a thickness of at most 5.0 μm. In some embodiments, the treatment mixture is applied to the ITM by jetting of the treatment mixture onto the ITM from at least one nozzle.

In step S23 of FIG. 4, a first image 264 is printed onto the ITM 201 having first treatment mixture 250 disposed thereon, for example using steps S3 to S6 of FIG. 3. The resulting first image 264 includes first printed dots 266 having a first diameter.

In step S24 of FIG. 4, which occurs at a different time than step S21 to S23, a second treatment mixture 270 is formed of the given quantity 252 of a liquid hydrophilic treatment formulation and a second quantity 274 of a liquid surfactant additive, the second quantity being larger than the first quantity 254. For example, the liquid hydrophilic treatment formulation and the liquid surfactant additive may be included in respective containers 94 and 96b of kit 98b (FIG. 1).

In step S25, the second treatment mixture 270 is applied to the surface of the same ITM 201 (e.g. ITM 44 of FIG. 1) to form thereon a second wet treatment layer 282. In some embodiments, the second wet treatment layer 282 has a thickness of at most 5.0 μm. In some embodiments, the treatment mixture is applied to the ITM by jetting of the second treatment mixture onto the ITM from at least one nozzle.

In step S26 of FIG. 4, a second image 284 is printed onto the ITM 201 having second treatment mixture 270 disposed thereon, for example using steps S3 to S6 of FIG. 3. The resulting second image 284 includes first printed dots 286 having a second diameter, smaller than the first diameter.

In some embodiments, the mixing at steps S21 and S24 may be automatic, and may be carried out within a mixing element of a printing system.

In some embodiments, the method may further include a step S30, prior to step S21, and a step S31, prior to step S24. In steps S30 and S31, the first quantity 254 and the second quantity 274, respectively, are selected, based on respective required resolutions of the first and second images to be printed. In some embodiments, the selection at steps S30 and S31 may be carried out automatically, for example by a processor of a control system controlling the printing system, based on the required resolutions of the first and second images.

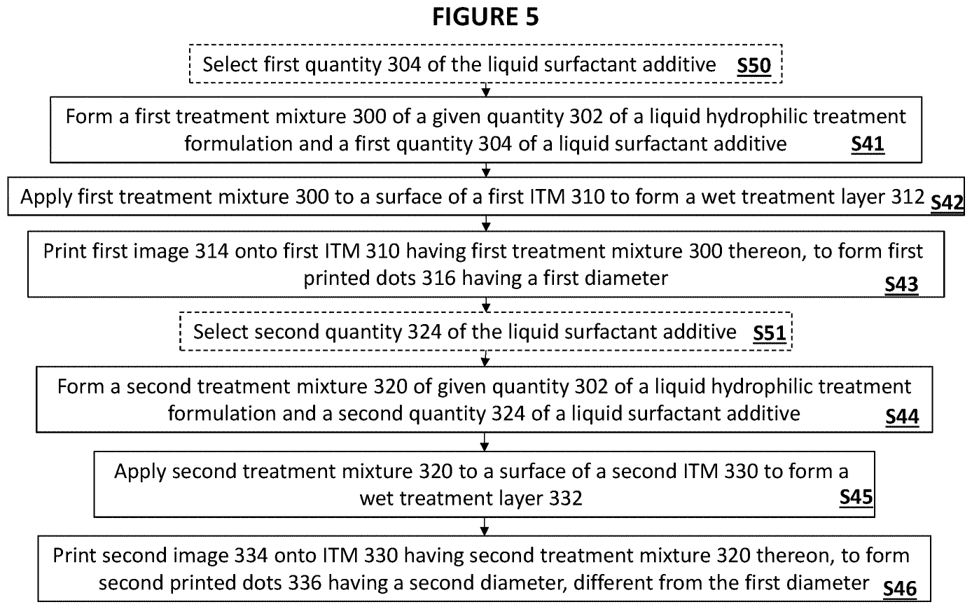

FIG. 5 is a flow chart of an indirect printing process according to some embodiments of the invention, implemented, for example, using the printing systems of FIG. 2.

In step S41 of FIG. 5, a first treatment mixture 300 is formed of a given quantity 302 of a liquid hydrophilic treatment formulation and a first quantity 304 of a liquid surfactant additive. For example, the liquid hydrophilic treatment formulation and the liquid surfactant additive may be included in respective containers 124 and 126a of kit 120a (FIG. 2).

In step S42, the first treatment mixture 300 is applied to a surface of a first ITM 310 (e.g. ITM of printing system 110a of FIG. 2) to form thereon a wet treatment layer 312. In some embodiments, the wet treatment layer 312 has a thickness of at most 5.0 μm. In some embodiments, the first treatment mixture is applied to first ITM 310 by jetting of the treatment mixture onto the first ITM from at least one nozzle.

In step S43 of FIG. 5, a first image 314 is printed onto the first ITM 310 having first treatment mixture 300 disposed thereon, for example using steps S3 to S6 of FIG. 3. The resulting first image 314 includes first printed dots 316 having a first diameter.

In step S44 of FIG. 5, a second treatment mixture 320 is formed of the given quantity 302 of a liquid hydrophilic treatment formulation and a second quantity 324 of a liquid surfactant additive, the second quantity being larger than the first quantity 304. For example, the liquid hydrophilic treatment formulation and the liquid surfactant additive may be included in respective containers 124 and 126b of kit 120b (FIG. 2).

In step S45, the second treatment mixture 320 is applied to the surface of a second ITM 330 (e.g. the ITM of printing system 110b of FIG. 2) to form thereon a second wet treatment layer 332. In some embodiments, the second wet treatment layer 332 has a thickness of at most 5.0 μm. In some embodiments, the second treatment mixture is applied to the second ITM by jetting of the second treatment mixture onto the second ITM from at least one nozzle.

In step S46 of FIG. 5, a second image 334 is printed onto the second ITM 330 having second treatment mixture 320 disposed thereon, for example using steps S3 to S6 of FIG. 3. The resulting second image 334 includes first printed dots 336 having a second diameter, smaller than the first diameter.

In some embodiments, steps S44-S46 occur concurrently with step S41-S43. In other embodiments, steps S44-S46 may occur at a different time than steps S41-S43.

In some embodiments, the mixing at steps S41 and S44 may be automatic, and may be carried out within a mixing element of the respective printing system.

In some embodiments, the method may further include a step S50, prior to step S41, and a step S51, prior to step S54. In steps S50 and S51, the first quantity 304 and the second quantity 324, respectively, based on respective required resolutions of the first and second images to be printed. In some embodiments, the selection at steps S50 and S51 may be carried out automatically, for example by respective processors of control systems controlling printing systems 120a and 120b, based on the required resolutions of the first and second images.

### C. Kit Description

As discussed hereinabove with respect to FIGS. 1 to 5, the present invention includes a kit having a liquid hydrophilic treatment formulation disposed in a first container (e.g. container 94 in FIG. 1) and a liquid surfactant additive disposed in a second container (e.g. container 96 in FIG. 1), such that the liquid hydrophilic treatment formulation is separate from the liquid surfactant additive. Typically, the liquid hydrophilic treatment formulation is devoid of the liquid surfactant additive, for example when disposed in the first container.

In some embodiments, a dry form of the hydrophilic treatment formulation is a non-cohesive form of a solid or semisolid material sweated with a non-volatile liquid oil.

In some embodiments, application of an aqueous ink onto an at least partially dry form of the hydrophilic treatment formulation applied to the ITM forms ink dots having a first diameter. However, application of the aqueous ink onto at least partially dry form of a mixture of a first quantity of the hydrophilic treatment formulation and a second quantity of the surfactant additive, which mixture was applied to the ITM, forms ink dots having a second diameter, smaller than the first diameter.

In some embodiments, a range of the ratio of the first diameter (dots printed using only the liquid hydrophilic treatment formulation) to the second diameter (dots printed using the mixture) is in the range of 1.05:1 to 2:1, or 1.05:1 to 3:1 or 1.05:1 to 4:1.

The second quantity (the quantity of the liquid surfactant additive) is significantly smaller than the first quantity (of the liquid hydrophilic treatment formulation).

In some embodiments, the second diameter is configurable by modification of a ratio between the first quantity of the liquid hydrophilic treatment formulation in the mixture and the second quantity of the liquid surfactant additive in the mixture.

In some embodiments, the mixture of a first quantity of the hydrophilic treatment formulation and a second quantity of the surfactant additive retains at least one of the following properties of the liquid hydrophilic treatment formulation, such as when it is disposed in the first container and is devoid of the liquid surfactant additive:
solubility;
clarity;
color;
reactivity with an aqueous ink used for printing on an ITM of a printing system (such as blanket 44 of FIG. 1);
ability to be applied to the ITM;
drying properties;
ability to form an ink film following deposit of aqueous ink onto a layer of the mixture;
mechanical properties; and
ability to be covered with a coating layer.

In some embodiments, the mixture is different in at least one of the following properties, from the liquid hydrophilic treatment formulation:
surface tension;
wetting; and
surface energy.

For example, in some embodiments, the mixture has a lower surface tension than the liquid hydrophilic treatment formulation in the first container. As another example, in some embodiments, the mixture has a lower surface energy than the liquid hydrophilic treatment formulation in the first container. As a further example, in some embodiments, the mixture has a lower wetting property than the liquid hydrophilic treatment formulation in the first container.

In some embodiments, the kit is such that each of the first and second containers is a separate sealed container.

In some embodiments, a volume of the first container is at least twice, at least three times, at least five times, at least ten times, at least 20 times, at least 50 times, or at least 100 times as large as a volume of the second container.

In some embodiments, the first quantity used in the mixture is equal to the volume of the first container. In some embodiments, the second quantity used in the mixture is equal to the volume of the second container.

In some embodiments, the second quantity is at most 2%, at most 1%, at most 0.5%, or at most 0.25% by weight of the first quantity.

In some embodiments, the second quantity is at least 0.05% or at least 0.1% by weight of the first quantity.

In some embodiments, in the mixture of the first quantity of the hydrophilic treatment formulation and the second quantity of the liquid surfactant additive, the liquid surfactant additive is in the range of 0.1% to 0.5% by weight of the mixture.

In some embodiments, the first quantity is in the range of 250 kg to 300 kg. In some embodiments, the second quantity is in the range of 0.5 kg to 1.0 kg.

In some embodiments, the liquid surfactant additive is a silicone-based surfactant.

In other embodiments, the liquid surfactant additive is a non-silicone-based surfactant.

In some embodiments, the liquid hydrophilic treatment formulation (also called herein the hydrophilic treatment formulation) comprises:
i. a liquid containing water, the liquid containing water making up between about 5% to about 97.5%, by weight, (at times between about 5% to about 95%, by weight) of the hydrophilic treatment formulation;
ii. at least one first non-ionic surfactant;
wherein the hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of the hydrophilic treatment formulation (e.g., when subjected to drying for example at a temperature of between about 90° C. to about 130° C., inclusive, to thereby substantially evaporate volatile liquids therefrom e.g., water and VOC) is a non-cohesive form of a solid or semisolid material sweated with a non-volatile liquid oil.

In some embodiments of the invention, the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

In some embodiments of the invention, the hydrophilic treatment formulation has the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight.

In some embodiments of the invention, the hydrophilic treatment formulation is devoid of a second water-soluble polymer, the second water-soluble polymer being different from the first water-soluble polymeric wetting agent.

In some embodiments of the invention, the second water-soluble polymer is a cohesive substance and/or a cohesion inducing substance.

In some embodiments of the invention, the second water-soluble polymer is a binder.

In some embodiments of the invention, the second water-soluble polymer is a water absorbing polymeric agent.

Non limiting examples of water absorbing polymeric agents which the hydrophilic treatment formulations of the invention are devoid of are: starches, including starch selected from corn starch, potato starch, rice starch, wheat flour, rice flour and corn flour.

In some embodiments of the invention, the second water-soluble polymer is a water absorbing polymeric agent with a repeating number of the monomeric unit thereof being 3 or above.

In some embodiments of the invention, the hydrophilic treatment formulation is devoid of a cohesive substance and/or a cohesion inducing substance, thereby once the hydrophilic treatment formulation or the mixture is dried on the silicone-based release layer surface of the ITM, it does not form a film layer thereon.

In some embodiments of the invention, the hydrophilic treatment formulation is substantially devoid of a film forming agent.

In some embodiments of the invention, the film forming agent is a binder.

In some embodiments of the invention, the hydrophilic treatment formulation may comprise a film forming agent, provided that the film forming agent is present in the formulations of the invention at a concentration that does not induce film formation on the ITM once the hydrophilic treatment formulation or the mixture is dried thereon.

In some embodiments of the invention, the hydrophilic treatment formulation is substantially devoid of a cohesive substance and/or a cohesion inducing substance, i.e., if such substances are present, they are present as very low concentration/s at which once the hydrophilic treatment formulation or the mixture is dried on the release layer surface of the ITM, it does not form a film layer thereon.

In some embodiments of the invention, the at least one wetting agent is the only polymeric substance in the formulation of the invention.

In some embodiments of the invention, one or more of the at least one first and/or second non-ionic surfactant may be of a polymeric nature (being considered as a polymeric substance). To this end, such surfactants are not considered as being cohesive substances and/or a cohesion inducing substances. Further to this end, such polymeric surfactants may be water soluble polymers, being non-cohesive polymers or non-cohesion inducing polymers, and being different from the second water-soluble polymer.

In some embodiments of the invention, one or more of the at least one first and/or second non-ionic surfactant may be of a polymeric nature, and are present in the formulations of the invention at a concentration that does not induce film formation on the ITM once the hydrophilic treatment formulation or the mixture is dried thereon.

In some embodiments of the invention, apart from the at least one first and/or second non-ionic surfactant, which may be of a polymeric nature (being considered as a polymeric substance), the hydrophilic treatment formulation is devoid of a second water-soluble polymer, the second water-soluble polymer being different from the first water-soluble polymeric wetting agent.

In some embodiments of the invention, one or more of the at least one first non-ionic surfactant may be of a polymeric nature (being considered as a polymeric substance) e.g., having for example a molecular weight of between about 1000 to 5000 g/mole. To this end, such surfactants are not considered as being cohesive substances and/or a cohesion inducing substances. Further to this end, such polymeric surfactants may be water soluble polymers, being non-cohesive polymers or non-cohesion inducing polymers.

In some embodiments of the invention, one or more of the at least one first non-ionic surfactant may be of a polymeric nature (being considered as a polymeric substance) and are present in the formulations of the invention at a concentration that does not induce film formation on the ITM once the hydrophilic treatment formulation or the mixture is dried thereon.

In some embodiments of the invention, apart from the at least one first non-ionic surfactant which may be of a polymeric nature (being considered as a polymeric substance), the hydrophilic treatment formulation is devoid of a second water-soluble polymer, the second water-soluble polymer being different from the first water-soluble polymeric wetting agent.

In some embodiments of the invention, the at least one wetting agent is a polymeric agent present in the formulations of the invention at a concentration that does not induce film formation on the ITM once the hydrophilic treatment formulation or the mixture is dried thereon.

In some embodiments of the invention, the hydrophilic treatment formulation is devoid of a second water-soluble polymeric substance. Such water-soluble polymeric substances have been disclosed in the patent publication to the Applicant WO/2020/141465 (PCT/IB2020/050001) [5] which content thereof is incorporated herein by reference.

In some embodiments of the invention, the second water-soluble polymer is a polymer with a repeating number of the monomeric unit thereof being 3 or above.

Non-limiting examples of excluded water-soluble polymeric substances are: at least one modified polysaccharide such as cellulose ether e.g., methylcellulose and hydroxypropyl methylcellulose (HPMC); a binder e.g., PVA 6-88 and Metochel K-3; a resin; polyvinyl alcohol (PVA); water-soluble cellulose, polyvinylpyrrolidone (PVP); polyethylene oxide, water-soluble acrylates, or any combination thereof.

Further non-limiting examples of excluded water-soluble polymeric substances are: polyvinyl alcohol (PVA), polyvinyl pyrrolidone (PVP), oxazoline, carbodiimide or any combination thereof.

Additional non-limiting examples of excluded water-soluble polymeric substances are water-soluble resin such as polyvinyl alcohol, polyvinyl pyrrolidone, polyvinyl acetal, polyalkylene oxide, starch, cellulose derivatives such as methyl cellulose, hydroxy cellulose, hydroxypropyl cellulose, hydroxypropylmethyl cellulose and carboxymethyl cellulose, polyamide, various kinds of a water-soluble resin containing a quaternary ammonium salt group, and derivatives thereof.

Additional non-limiting examples of excluded water-soluble polymeric substances are synthetic rubber such as vinyl acetate resins, ethylene vinyl acetate reins, acrylic reins, epoxy resins, polyester resins, polyamide resins, urethane resins, styrene-butadiene resins, acrylo-nitrile-butadiene resins and acrylic-butadiene resins.

In some embodiments of the invention, the hydrophilic treatment formulation of the invention is devoid of Methocel K3.

In some embodiments of the invention, the hydrophilic treatment formulation may be devoid of wax.

In some embodiments of the invention, the liquid containing water of the hydrophilic treatment formulation is water only or a mixture of water and at least one water soluble organic solvent e.g., ethanol and the like.

Non-limiting examples of liquid containing water may be one or more water-soluble organic solvent such as alcohols, glycols, alkylene glycols having an alkylene group with a carbon number of 2 to 6, polyethylene glycols (provided that same are non-polymeric e.g., with numerous repeating units which are not considered polymeric), nitrogen-containing compounds, and sulfur-containing compounds.

In some embodiments of the invention, the hydrophilic treatment formulation may further comprise at least one first water-soluble polymeric wetting agent.

In some embodiments of the invention, the first water-soluble polymeric wetting agent is a multiple charged polymer e.g., a polycation or a polyanion.

Non limiting examples of a polycationic first water-soluble polymeric wetting agent are polyethyleneimine (PEI), poly(amidoamine) (PAMAM), poly-l-lysine (PLL) and poly(diallyl dimethyl ammonium) (PDDA).

In some embodiments of the invention the first water-soluble polymeric wetting agent is PEI.

In some embodiments of the invention the PEI is one or more of the following exemplary PEIs:

| | Charge | Molecular |
|---|---|---|
| | Density, | Weight |
| Chemical Agent [Brand name] | meq/g | (gr/mole) |
| Polyethyleneimine (PEI) | 16 | 800 |
| [Lupasol ® FG] | | |
| PEI [Lupasol ® G 100] | 17 | 5,000 |
| PEI [Lupasol ® G 20] | 16 | 1,300 |
| PEI [Lupasol ® G 20 Waterfree] | 16 | 1,300 |
| PEI [Lupasol ® G 35] | 16 | 2,000 |
| PEI [Lupasol ® HF] | 17 | 25,000 |
| PEI [Lupasol ® P] | 20 | 750,000 |
| PEI, modified | | 1,000,000 |
| [Lupasl ® PN 50] | | |
| PEI, modified | | n/a |
| [Lupasol ® PN 60] | | |
| PEI, modified | | 2,000 |
| [Lupasol ® PO 100] | | |
| PEI [Lupasol ® PR 8515] | 16 | 2,000 |
| PEI [Lupasol ® PS] | 20 | 750,000 |
| PEI, modified [Lupasol ® SK] | 8 | 2,000,000 |
| PEI [Lupasol ® WF] | 17 | 25,000 |

In some embodiments of the invention the PEI is provided in an aqueous solution (Lupasol® PS, BASF).

In some embodiments of the invention the PEI is provided in an aqueous solution (Lupasol® MI 6730).

In some embodiments of the invention the wetting agent is Poly(diallyldimethylammonium chloride) e.g., having Charge Density of about 6 meq/g and a molecular weight of about 200,000-300,000 gr/mole.

Non-limiting examples of a polyanionic first water-soluble polymeric wetting agent are acrylic polymers, polyacryl amides and poly-DADMAc.

In some embodiments of the invention, apart from the first water-soluble polymeric wetting agent (e.g., polyethyleneimine) and at times apart from the at least one first and/or the at least one second non-ionic surfactants, the hydrophilic treatment formulation is devoid of a substance with a molecular weight being of about 1300 gr/mol and above. To this end, the hydrophilic treatment formulation might be referred to as small molecules containing treatment formulation.

Without wishing to be bound by theory, it is noted that while small molecules reduce the adhesion to the ITM at a scale of about 1:1, their effect on cohesion reduction is exponential, hence, presence of small molecules substances in the hydrophilic treatment formulation of the invention allows avoidance of cohesion between the formulation components but still maintaining the adhesion to the ITM, with the latter still being weaker than that of the adhesion to the final substrate for good transfer performance, optionally with no splitting of the non-cohesive layer during transfer (which is a relatively thick layer compared to a thinner layer of about 1 to 10 nm thickness known in the art e.g., WO/2015/036960 (PCT/IB2014/064444) [2]).

In some embodiments, one or more of the first and/or one or more of the second non-ionic surfactants may be of a molecular weight of between about 400 gr/mole to about 5000 gr/mole (inclusive), at times between about 1000 gr/mole to about 5000 gr/mole, inclusive. Any value in the above noted ranges is within the scope of the present invention.

In some embodiments, one or more of the first non-ionic surfactants may be of a molecular weight of between about 400 gr/mole to about 5000 gr/mole (inclusive), at times between about 1000 gr/mole to about 5000 gr/mole, inclusive. Any value in the above noted ranges is within the scope of the present invention.

It is noted that as opposed to small molecules, which may have a unique molecular weight readily derived from their chemical formula, generally provided in grams/mole, polymers and other macromolecules typically exist as a diverse population of distinct molecules, which are therefore characterized by an average molecular weight which may be expressed in Daltons. The molecular weight or average molecular weight of materials are generally provided by the manufacturer or supplier but can be independently determined by known analytical methods, including for instance gel permeation chromatography, high pressure liquid chromatography (HPLC) or matrix-assisted laser desorption/ionization time-of-flight mass spectroscopy MALDI-TOF MS. Average molecular weight (D50) may be based on the number of particles in the population (“D_{N}50”) or may be based on the volume of particles (D_{V}50). These measurements may be obtained by various known methods (e.g., DLS, microscopy). Thus, in some embodiments the molecular weigh value of components of the formulations of the present invention is an average molecular weight.

In some embodiments of the invention, the at least one wetting agent may be a plasticizer and/or a surface-active agent and/or an anchoring agent.

In some embodiments of the invention, the hydrophilic treatment formulation is further devoid of one or more of an inorganic salt, an inorganic metallic compound (e.g., Magnesium Nitrate Hexahydrate), a polyvalent metal ion and a metal ion.

In some embodiments of the invention, the hydrophilic treatment formulation is further devoid of an acid e.g., an organic acid.

In some embodiments of the invention, the hydrophilic treatment formulation is further devoid of a resolubilizing agent.

Non-limiting examples of excluded resolubilizing agents are diols, triols, polyols, alcohols, sugars and modified sugars, ethers, polyethers, amino alcohol, amino silicones, styrene sulfonates, and combinations thereof.

Further non-limiting examples of excluded resolubilizing agents are cocoamide diethanol amine, ethoxylated methyl glucose ether, Glucam™ E-10, Glucam™ E-20, glycerol, pentaerythritol, PEG 400, PEG 600, poly(sodium-4-styrenesulfonate), SilSense® Q-Plus Silicone, SilSense® A21 Silicone, sucrose, triethanol amine, triethylene glycol monomethyl ether, glycerol and triethanolamine.

In some embodiments of the invention, the hydrophilic treatment formulation is devoid of one or more of the ingredients excluded herein above and below.

In some embodiments of the invention, the hydrophilic treatment formulation is devoid of one or more of: a second water-soluble polymer; a cohesive substance and/or a cohesion inducing substance; a substance with a molecular weight being of about 1300 gr/mol and above; one or more of an inorganic salt, an inorganic metallic compound (e.g., Magnesium Nitrate Hexahydrate), a polyvalent metal ion and a metal ion; acid e.g., an organic acid; resolubilizing agent; or any combination thereof.

In some embodiments of the invention, the hydrophilic treatment formulation is devoid of one or more of: a second water-soluble polymer (as detailed above); a cohesive substance and/or a cohesion inducing substance; a substance with a molecular weight being of about 1300 gr/mol and above (at times, apart from the at least one first and/or the at least one second non-ionic surfactants which at times may be of a higher molecular weight); one or more of an inorganic salt, an inorganic metallic compound (e.g., Magnesium Nitrate Hexahydrate), a polyvalent metal ion and a metal ion; acid e.g., an organic acid; resolubilizing agent; or any combination thereof. In some embodiments of the invention, the total percent solids by weight of the hydrophilic treatment formulation is at least about 5%, or between about 5% to about 95% (inclusive), in particular between about 27% to about 95% (inclusive), even more particular between about 35% to about 95% (inclusive). Any value in the above noted ranges is within the scope of the present invention.

In some embodiments of the invention, the total percent solids by weight of the hydrophilic treatment formulation is between about 27% to about 40% (inclusive), in particular between about 29% to about 39% (inclusive). Any value in the above noted ranges is within the scope of the present invention.

In some embodiments of the invention, the total percent solids by weight of the hydrophilic treatment formulation between about 29% to 34%.

In some embodiments of the invention, the total percent solids by weight of the hydrophilic treatment formulation is 37.83%.

In some embodiments of the invention, the total percent solids by weight of the hydrophilic treatment formulation is 34.20%.

In some embodiments of the invention, the total percent solids by weight of the hydrophilic treatment formulation is 38.51%.

In some embodiments of the invention, the hydrophilic treatment formulation has a 60° C. evaporation load of at least about 1.86:1 by weight.

In some embodiments of the invention, the least one first non-ionic surfactant has a solubility in water of at least about 7%, at 25° C.

In some embodiments of the invention, the first non-ionic surfactant is a silicon containing surfactant or a non-silicon containing surfactant (e.g., polysorbate 20 i.e., Tween 20).

In some embodiments of the invention, the first non-ionic surfactant is a non-silicon containing surfactant. In some embodiments of the invention, the first non-ionic surfactant is a non-silicon surfactant.

In some embodiments of the invention, the least one first non-ionic surfactant makes up between about 0.0% to about 95% (inclusive), by weight, of the hydrophilic treatment formulation. To this end, when a concentration of the at least one first non-ionic surfactant is 0.0% i.e., null, the hydrophilic treatment formulation comprises at least one another first non-ionic surfactant, at times at least two other first non-ionic surfactants.

In some embodiments of the invention, the least one first non-ionic surfactant makes up between about 2.5% to about 95% (inclusive), by weight, of the hydrophilic treatment formulation, at times between about 5% to about 95% (inclusive), at times between about 10% to about 95% (inclusive), at times between about 15% to about 95% (inclusive), at times between about 20% to about 95% (inclusive), at times between about 25% to about 95% (inclusive), even at times between about 35% to about 95% (inclusive), by weight, of the hydrophilic treatment formulation. Any value in the above noted ranges is within the scope of the present invention.

In some embodiments of the invention, the least one first non-ionic surfactant makes up about 24%, by weight, of the hydrophilic treatment formulation.

In some embodiments of the invention, the least one first non-ionic surfactant makes up between about 2.5% to about 24% (inclusive), by weight, of the hydrophilic treatment formulation. Any value in the above noted range is within the scope of the present invention.

In some embodiments of the invention, the least one first non-ionic surfactant makes up between about 5.5% to about 24% (inclusive), by weight, of the hydrophilic treatment formulation. Any value in the above noted range is within the scope of the present invention.

In some embodiments of the invention, the least one first non-ionic surfactant makes up between about 8.0% to about 15% (inclusive), by weight, of the hydrophilic treatment formulation. Any value in the above noted range is within the scope of the present invention.

In some embodiments of the invention, the least one first non-ionic surfactant makes up between about 8.0% to about 11.6% (inclusive), by weight, of the hydrophilic treatment formulation. Any value in the above noted range is within the scope of the present invention.

In some embodiments of the invention, the hydrophilic treatment formulation of the invention may comprise at least two first non-ionic surfactants, at times at least three first non-ionic surfactants.

In some embodiments of the invention, when the hydrophilic treatment formulation comprises more than one first non-ionic surfactant (e.g., at least two first non-ionic surfactants, at least three first non-ionic surfactants etc.) a total content of the first non-ionic surfactants makes up between about 2.5% to about 95% (inclusive), by weight, of the hydrophilic treatment formulation, at times between about 5% to about 95% (inclusive), at times between about 10% to about 95% (inclusive), at times between about 15% to about 95% (inclusive), at times between about 20% to about 95% (inclusive), at times between about 25% to about 95% (inclusive), even at times between about 35% to about 95% (inclusive), by weight, of the hydrophilic treatment formulation. Any value in the above noted ranges is within the scope of the present invention.

In some embodiments of the invention, the second non-ionic surfactant is a silicon containing surfactant (e.g., BYK LPX 23289) or a non-silicon containing surfactant.

In some embodiments of the invention, the second non-ionic surfactant is a non-silicon containing surfactant.

Non-limiting examples of first and second non-ionic surfactants are those which have been disclosed in the patent publication to the Applicant WO/2019/111223 (PCT/IB2018/059761) [4] which content thereof is incorporated herein by reference.

In some embodiments of the invention, the first and the second non-ionic surfactants are non-silicon containing surfactants.

In some embodiments of the invention, the first and the second non-ionic surfactant are non-silicon surfactants.

In some embodiments of the invention, one or more of the first non-ionic surfactants are non-silicon containing surfactants.

In some embodiments of the invention, one or more of the second non-ionic surfactants are non-silicon containing surfactants.

In some embodiments of the invention, one or more of the first non-ionic surfactants are non-silicon surfactants.

In some embodiments of the invention, one or more of the second non-ionic surfactants are non-silicon surfactants.

In some embodiments the hydrophilic treatment formulation of the invention is devoid of a silicon containing surfactant.

In some embodiments the hydrophilic treatment formulation of the invention is devoid of a silicon surfactant.

In some embodiments the hydrophilic treatment formulation of the invention is devoid of the silicon surfactant BYK 23289.

Without wishing to be bound by theory, low contents of silicon surfactants in the formulations of the invention or absence thereof are advantageous at least in terms of less available sources of silicon on the planet. Further, silicone containing surfactants cause foaming of the formulations and avoiding of same is advantageous to the printing process and as well as the resulted printed article.

In some embodiments of the invention, the first non-ionic surfactant is, mainly includes, or includes a polyethoxylated sorbitan ester.

In some embodiments of the invention, the first non-ionic surfactant is, mainly includes, or includes a polyethoxylated sorbitan ester (e.g., Tween 20).

In some embodiments of the invention, the polyethoxylated sorbitan ester includes at least one species or at least two species selected from the group consisting of PEG-4 sorbitan monolaurate, PEG-20 sorbitan monolaurate, PEG-20 sorbitan monopalmitate, PEG-20 sorbitan monostearate, and PEG-20 sorbitan monooleate.

In some embodiments of the invention, the first non-ionic surfactant is, mainly includes, or includes a polyether such as Poly(propylene glycol)-block-poly(ethylene glycol)-block-poly(propylene glycol) (e.g., Pluronic 10R5).

In some embodiments of the invention, the first non-ionic surfactant is, mainly includes, or includes a glycoside such as alkyl polyglycoside C8-10 (e.g., Disponil APG 215).

In some embodiments of the invention the hydrophilic treatment formulation comprises a first non-ionic surfactant selected from a polyethoxylated sorbitan ester (e.g., Tween 20), a polyether (e.g., Pluronic 10R5), a glycoside (e.g., Disponil APG 215) or any combinations thereof.

In some embodiments of the invention, the at least one first non-ionic surfactant is Tween 20, making up between about 0.0% to about 95% (inclusive), at times between about 2.5% to about 95% (inclusive), by weight, of the hydrophilic treatment formulation. Any value in the above noted ranges is within the scope of the present invention.

In some embodiments of the invention, the at least one first non-ionic surfactant is Tween 20, making up between about 2.5% to about 24% (inclusive), by weight, of the hydrophilic treatment formulation. Any value in the above noted range is within the scope of the present invention.

In some embodiments of the invention, the at least one first non-ionic surfactant is Tween 20, making up between about 5.5% to about 24% (inclusive), by weight, of the hydrophilic treatment formulation. Any value in the above noted range is within the scope of the present invention.

In some embodiments of the invention, the at least one first non-ionic surfactant is Pluronic 10R5, making up between about 0.0% to about 95% (inclusive), at times between about 2.5% to about 95% (inclusive), by weight, of the hydrophilic treatment formulation. Any value in the above noted ranges is within the scope of the present invention.

In some embodiments of the invention, the at least one first non-ionic surfactant is Pluronic 10R5, making up between about 8.0% to about 15% (inclusive), by weight, of the hydrophilic treatment formulation. Any value in the above noted range is within the scope of the present invention.

In some embodiments of the invention, the at least one first non-ionic surfactant is Disponil APG 215, making up between about 0.0% to about 64% (inclusive), at times between about 2.5% to about 64% (inclusive), by weight, of the hydrophilic treatment formulation. Any value in the above noted ranges is within the scope of the present invention.

In some embodiments of the invention, at the least one first non-ionic surfactant is Disponil APG 215, making up between about 8.0% to about 11.6% (inclusive), by weight, of the hydrophilic treatment formulation. Any value in the above noted range is within the scope of the present invention.

In some embodiments of the invention, the hydrophilic treatment formulation comprises a polyethoxylated sorbitan ester first non-ionic surfactant, a polyether first non-ionic surfactant, and a glycoside first non-ionic surfactant, wherein the polyethoxylated sorbitan ester making up between about 2.5% to about 24% (inclusive), at times between about 5.5% to about 24% (inclusive), event at times between about 2.5% to about 6.0% (inclusive), by weight, of the hydrophilic treatment formulation, wherein the polyether making up between about 8.0% to about 15% (inclusive), by weight, of the hydrophilic treatment formulation, and wherein the glycoside making up between about 8.0% to about 11.6% (inclusive), by weight, of the hydrophilic treatment formulation. Any value in the above noted ranges is within the scope of the present invention.

In some embodiments of the invention, the hydrophilic treatment formulation comprises the first non-ionic surfactants Tween 20, Pluronic 10R5, and Disponil APG 215, wherein the Tween 20 making up between about 2.5% to about 24% (inclusive), at times between about 5.5% to about 24% (inclusive), event at times between about 2.5% to about 6.0% (inclusive), by weight, of the hydrophilic treatment formulation, wherein the Pluronic 10R5 making up between about 8.0% to about 15% (inclusive), by weight, of the hydrophilic treatment formulation, and wherein the Disponil APG 215 making up between about 8.0% to about 11.6% (inclusive), by weight, of the hydrophilic treatment formulation. Any value in the above noted ranges is within the scope of the present invention.

In some embodiments of the invention, the at least one second non-ionic surfactant has a solubility in water of at least 1%, at 25° C.

In some embodiments of the invention, the second, non-ionic silicone-containing surfactant includes a polysiloxane-polyoxyalkylene copolymer.

In some embodiments of the invention, the second non-ionic surfactant making up at most 10%, by weight, (inclusive) of the hydrophilic treatment formulation. Any value between 0% to 10% (inclusive), at times between 0% to 5.0% (inclusive), is within the scope of the present invention.

In some embodiments of the invention, the second non-ionic surfactant makes up about 4%, by weight of the hydrophilic treatment formulation.

In some embodiments of the invention, the second non-ionic surfactant makes up about 5%, by weight of the hydrophilic treatment formulation.

In some embodiments of the invention, the second non-ionic surfactant is, mainly includes, or includes a thioether (e.g., Dynol 360).

In some embodiments of the invention, the second non-ionic surfactant is, mainly includes, or includes an ethoxylated alcohol such as ethoxylated acetylenic diols (e.g., Dynol 604) and/or ethoxylated 2,4,7,9-tetramethyl 5 decyn-4,7-diol (e.g., Surfinol 465).

In some embodiments of the invention, the second non-ionic surfactant is an ethoxylated alcohol selected from ethoxylated acetylenic diols (e.g., Dynol 604), ethoxylated 2,4,7,9-tetramethyl 5 decyn-4,7-diol (e.g., Surfinol 465) or a combination thereof.

In some embodiments of the invention, the second non-ionic surfactant is selected from a thioether, an ethoxylated alcohol or any combination thereof.

In some embodiments of the invention the hydrophilic treatment formulation comprises a second non-ionic surfactant selected from at least one thioether, at least one ethoxylated alcohol or any combination thereof.

In some embodiments of the invention the hydrophilic treatment formulation comprises a second non-ionic surfactant selected from Dynol 360, Dynol 604, Surfinol 465 or any combinations thereof.

In some embodiments of the invention the hydrophilic treatment formulation is devoid of a second non-ionic surfactant selected from Dynol 360, Dynol 604, Surfinol 465 or any combinations thereof.

In some embodiments of the invention, the at least one second non-ionic surfactant is Dynol 360, making up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the at least one second non-ionic surfactant is Dynol 604, making up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the at least one second non-ionic surfactant is Surfinol 465, making up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the hydrophilic treatment formulation of the invention may comprise at least two second non-ionic surfactants, at times at least three non-ionic surfactants.

In some embodiments of the invention, when the hydrophilic treatment formulation comprises more than one second non-ionic surfactant (e.g., two second non-ionic surfactants, three second non-ionic surfactants etc.) a total content of the second non-ionic surfactants makes up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the hydrophilic treatment formulation comprises a polyethoxylated sorbitan ester first non-ionic surfactant, a polyether first non-ionic surfactant, and a glycoside first non-ionic surfactant, wherein the polyethoxylated sorbitan ester making up between about 2.5% to about 24% (inclusive), at times between about 5.5% to about 24% (inclusive), by weight, of the hydrophilic treatment formulation, wherein the polyether making up between about 8.0% to about 15% (inclusive), by weight, of the hydrophilic treatment formulation, and wherein the glycoside making up between about 8.0% to about 11.6% (inclusive), by weight, of the hydrophilic treatment formulation; and wherein the hydrophilic treatment formulation may further comprise a second non-ionic surfactant selected from at least one thioether, at least one ethoxylated alcohol or any combination thereof, wherein a total content of the second non-ionic surfactant makes up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the hydrophilic treatment formulation comprises the first non-ionic surfactants Tween 20, Pluronic 10R5, and Disponil APG 215, wherein the Tween 20 making up between about 2.5% to about 24% (inclusive), at times between about 5.5% to about 24% (inclusive), by weight, of the hydrophilic treatment formulation, wherein the Pluronic 10R5 making up between about 8.0% to about 15% (inclusive), by weight, of the hydrophilic treatment formulation, and wherein the Disponil APG 215 making up between about 8.0% to about 11.6% (inclusive), by weight, of the hydrophilic treatment formulation; and wherein the hydrophilic treatment formulation may further comprise a second non-ionic surfactant selected from Dynol 360, Dynol 604, Surfinol 465 or any combinations thereof, wherein a total content of the second non-ionic surfactant makes up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the hydrophilic treatment formulation may further comprise at least one wetting agent (e.g., polyethyleneimine), the wetting agent (e.g., polyethyleneimine) making up at most about 1%, by weight, of the hydrophilic treatment formulation, in particular at most about 0.20%, more particular 0.20% of the hydrophilic treatment formulation. Any value between 0 to 1% is within the scope of the present invention.

In some embodiments of the invention, the hydrophilic treatment formulation may further comprise at least one humectant, the humectant making up at most about 30%, by weight, of the hydrophilic treatment formulation. Any value between 0 to 30% is within the scope of the present invention.

In some embodiments of the invention, the humectant makes about 10%, by weight, of the hydrophilic treatment formulation.

In some embodiments of the invention, the humectant is a sugar making about 10%, by weight, of the hydrophilic treatment formulation.

In some embodiments of the invention, the at least one humectant is a non-polymeric humectant (e.g., sorbitol, xylitol, a monosaccharide, a disaccharide).

To this end, in some embodiments of the invention the hydrophilic treatment formulation is devoid of polysaccharides such starch, cellulose, guar gum, locust bean gum, fenugreek gum, Tara gum, curdlan, and carrageenan. Also cationic polysaccharide such as polysaccharides combined with an amino group and an amine salt; natural polysaccharides, such as chitosan, containing an amino group; quaternary or ternary nitrogen-containing halides such as glycidyltrimethylammonium chloride, 3-chloro-2-hydroxypropyltrimethylammonium chloride, 3-chloropropyltrimethylammonium chloride, and glycidyltriethylammonium chloride; halohydrins; and epoxides are excluded from the hydrophilic treatment formulation of the invention.

In some embodiments of the invention, an HLB number of a first and/or a second non-ionic surfactant is at least 11, at least 12, at least 13, at least 14, or at least 14.5, and optionally, at most 22, at most 21, at most 20, at most 19, at most 18, or at most 17, and further optionally, within a range of 11 to 25, 11 to 23, 11.5 to 21, 11.5 to 20, 11.5 to 18, 12.5 to 21, 12.5 to 20, 12.5 to 18, 13.5 to 21, 13.5 to 20, 13.5 to 18, 14 to 20.5, 14 to 18.5, 14.5 to 20, 14.5 to 19, 14.5 to 18, or 14.5 to 17.5.

In some embodiments of the invention, the HLB number of the first and/or second non-ionic surfactant is within the range of 11 to 25.

In some embodiments of the invention, the HLB number of the first and/or second non-ionic surfactant is within the range of 14.5 to 20.

In some embodiments of the invention, the hydrophilic treatment formulation may further comprise at least one antibacterial agent (e.g., K12N or any other antibacterial agent known in the art), wherein the antibacterial agent making up at most about 1%, by weight, of the hydrophilic treatment formulation. Any value between 0 to 1% is within the scope of the present invention.

In some embodiments of the invention, the antibacterial agent makes about 0.20%, by weight, of the hydrophilic treatment formulation.

In some embodiments of the invention, the hydrophilic treatment formulation comprises one or more of:
at least one first non-ionic surfactant, the first non-ionic surfactant making up between about 2.5% to about 95%, by weight (at times between about 5% to about 95%, by weight), of the hydrophilic treatment formulation.
at least one second non-ionic surfactant, the second non-ionic surfactant making up at most 10%, by weight, (inclusive) of the hydrophilic treatment formulation;
at least one wetting agent, the wetting agent (e.g., polyethyleneimine) making up at most about 1%, by weight, of the hydrophilic treatment formulation, in particular at most about 0.20%, more particular 0.20% of the hydrophilic treatment formulation;
at least one humectant, the humectant making up at most about 30%, by weight, of the hydrophilic treatment formulation; and
at least one antibacterial agent making up at most about 1%, by weight, of the hydrophilic treatment formulation.

It is noted that any value in the range of the ingredient's content (% by weight) detailed herein above and below is withing the scope of the present invention.

In some embodiments of the invention, the at least one humectant is a non-polymeric humectant e.g., sorbitol, xylitol, a monosaccharide, a disaccharide.

In some embodiments of the invention, the ingredients of the hydrophilic treatment formulation are compatible with each other and with the liquid containing water, thus the hydrophilic treatment formulation being a stable solution with no phase separation and with no sedimentation/precipitation at 25° C.

In some embodiments of the invention, the hydrophilic treatment formulation is a clear colorless solution at 25° C.

In some embodiments of the invention, the hydrophilic treatment formulation is a transparent solution at 25° C.

Exemplary non limiting list of surfactants that provide clear colorless solution (transparent solution) of the hydrophilic treatment formulation of the present invention, alone or in any combination with each other, are Tween 20, Pluronic 10R5, Disponil APG 215, Dynol 360, Dynol 604 and Surfinol 465.

In some embodiments of the invention, the ingredients of the hydrophilic treatment formulation do not form aggregates with the colorant of an aqueous ink utilized in the printing system/process.

In some embodiments of the invention, the hydrophilic treatment formulation of the invention has the following content (referred to herein as Formulation A):

| | | Concentration |
|---|---|---|
| | Components | w/w % |
| | BYK 23289 | 3.82 |
| | Loxanol MI 6730 | 0.2 |
| | Sugar | 9.60 |
| | Tween 20 | 24.01 |
| | Mergal K12N | 0.20 |
| | Water | 62.17 |
| % solids | | 37.83% |

In some embodiments of the invention, the hydrophilic treatment formulation of the invention has the following content (referred to herein as Formulation C):

| | | Concentration |
|---|---|---|
| | Components | w/w % |
| | Pluronic 10R5 | 8.1 |
| | Disponil APG 215 | 11.6 |
| | Loxanol MI 6730 | 0.2 |
| | Sugar | 7.7 |
| | Dynol 360 | 3.90 |
| | Tween 20 | 2.5 |
| | Mergal K12N | 0.20 |
| | Water | 65.8 |
| % solids | | 34.2% |

In some embodiments of the invention, the hydrophilic treatment formulation of the invention has the following content (referred to herein as Formulation D):

| | | Concentration |
|---|---|---|
| | Components | w/w % |
| | Pluronic 10R5 | 14.7 |
| | Disponil APG 215 | 8.8 |
| | Loxanol MI 6730 | 0.29 |
| | Sugar | 8.8 |
| | Tween 20 | 5.9 |
| | Mergal K12N | 0.20 |
| | Water | 61.31 |
| % solids | | 38.51% |

In some embodiments of the invention, the hydrophilic treatment formulation of the invention has the following content (referred to herein as Formulation E):

| | | Concentration |
|---|---|---|
| | Components | w/w % |
| | Pluronic 10R5 | 8.1 |
| | Disponil APG 215 | 11.6 |
| | Loxanol MI 6730 | 0.2 |
| | Sugar | 7.7 |
| | Tween 20 | 2.5 |
| | Mergal K12N | 0.20 |
| | Water | 69.7 |
| % solids | | 34.2% |

In some embodiments of the invention, the hydrophilic treatment formulation of the invention has the following content (referred to herein as Formulation F):

| | | Concentration |
|---|---|---|
| | Components | w/w % |
| | Pluronic 10R5 | 14.7 |
| | Disponil APG 215 | 8.8 |
| | Loxanol MI 6730 | 0.2 |
| | Sugar | 7.7 |
| | Tween 20 | 2.5 |
| | Mergal K12N | 0.20 |
| | Water | 65.9 |
| % solids | | 34.2% |

In some embodiments of the invention, the hydrophilic treatment formulations of the invention have the following content (various concentration ranges of the components are provided):

| | | Concentration |
|---|---|---|
| | Components | w/w % |
| | Pluronic 10R5 | 8.0-15.0 |
| | Disponil APG 215 | 8.0-11.6 |
| | Loxanol MI 6730 | 0.2 |
| | Sugar | 7.7 |
| | Dynol 360 | 0-5 |
| | Tween 20 | 2.5 |
| | Mergal K12N | 0.20 |
| | Water | Complete to |
| | | 100% total |
| % solids | | ~29-34% |

Other concentration ranges are within the scope of the present invention.

In another one of its aspects the present invention provides a method of indirect printing comprising:
a. providing an intermediate transfer member (ITM) comprising a release layer surface;
b. providing the mixture of the invention;
c. applying the mixture onto the release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. drying the wet treatment layer to thereby form a dried non-cohesive sweating treatment layer from the wet treatment layer on the ITM release layer surface, the dried non-cohesive sweating treatment layer optionally having a thickness of at least about 20 nm and at most about 500 nm (at times at most about 450, 400, 350, 300, 250 or 200 nm);
e. depositing droplets of an aqueous ink, the aqueous ink comprising at least one binder and at least one colorant, onto at least a region of the dried non-cohesive sweating treatment layer, to form an ink image on the ITM release layer surface;
f. drying the ink image to leave an ink-image residue on the ITM release layer surface; and
g. transferring the ink-image residue onto a printing substrate by pressured contact between the ITM and the printing substrate.

In some embodiments of the invention, the drying in step (b) may be by keeping the ITM at a temperature sufficient to dry the wet treatment layer for example a temperature between about 90° C. to about 130° C., and/or by subjecting the wet treatment layer to a drying process.

In some embodiments of the invention the drying in step (b) may be by keeping the ITM at a temperature sufficient to dry the wet treatment layer for example a temperature between about 90° C. to about 130° C.

In some embodiments of the invention the drying in step (b) may be by subjecting the wet treatment layer to a drying process.

In some embodiments of the invention, the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

In some embodiments of the invention, the hydrophilic treatment formulation and/or the mixture is substantially devoid of a cohesive substance and/or a cohesion inducing substance thereby once the hydrophilic treatment formulation or the mixture is dried on the release layer surface of the ITM it does not form a film layer thereon.

In some embodiments of the invention, the hydrophilic treatment formulation or the mixture may comprise a cohesive substance and/or a cohesion inducing substance at concentrations that are insufficient to form a film layer on the release layer surface of the ITM once the hydrophilic treatment formulation or the mixture is dried thereon.

In some embodiments, in the method of the invention the drying in step (d) is performed at a temperature of between about 90° C. to about 130° C., inclusive.

In some embodiments of the invention, the dried non-cohesive sweating treatment layer is comprised of a solid material sweated with a non-volatile liquid oil.

In some embodiments of the invention, the dried non-cohesive sweating treatment layer is comprised of a semisolid material sweated with a non-volatile liquid oil.

In some embodiments of the invention, the dried non-cohesive sweating treatment layer is colorless.

In some embodiments of the invention, the ingredients of the hydrophilic treatment formulation do not form aggregates with the colorant of the aqueous ink.

In some embodiments, in the method of the invention, in step (g), to some extent, the dry non-cohesive sweating treatment layer, in both printed and non-printed regions on the ITM, is transferred to the printing substrate, together with the ink-image residue, leaving a residual dry non-cohesive sweating treatment layer on the ITM or a residual dry non-cohesive non-sweating treatment layer on the ITM.

Without wishing to be bound by theory, at times the transfer may result in leaving a residual dry non-cohesive treatment layer without the liquid oil i.e., leaving a non-sweated dry non-cohesive treatment layer, the latter comprises solids or semisolids only or mainly comprises solids or semisolids (optionally with trace amount of oil phase).

In some embodiments of the invention, the method comprises several repeating cycles of steps (c) to (g) (e.g., 1000 cycles), and wherein between each cycle the newly applied mixture in step (c) completely dissolves/solubilize the residual dry non-cohesive sweating treatment layer or the residual dry non-cohesive non-sweating treatment layer of the previous cycle, thereby no accumulation of the residual layer/s between each of the cycles occurs. To this end, the need of a cleaning station for cleaning the ITM may be redundant. Further to this end, utilizing re-solubilization agents in the mixture may be redundant.

In some embodiments, in the method of the invention, the droplets of the aqueous ink are deposited onto the dry non-cohesive sweating treatment layer, a surface of the dry non-cohesive sweating treatment layer, which is in close contact with the aqueous ink, is capable of dissolving into the aqueous ink and/or mix and/or blend with the aqueous ink, optionally forming an intermediate phase comprising one or more ingredients of the mixture and the ink ingredients.

The inventors of the present invention have surprisingly found that the mixture of the present invention provide advantages to the printing process as detailed herein above when utilized with a broad spectrum of inks (e.g., Y, M, C, K, O, G, B) and thus are considered as universal to all inks including e.g., R and W, without manifestation of any damage to the printing quality, color gamut etc.

The mixture of the present invention is also applicable to be used with inks of relatively high static surface tension (being of above 25.5 mN/m at room temperature, for example about 26 mN/m) as well as low surface tension (being of about 23.0 to about 25.5 mN/m at room temperature, for example about 24 mN/m). Such exemplary inks are disclosed in U.S. Provisional Application No. 63/362,971 [17], the content of each is incorporated herein by reference. Without wishing to be bound by theory, in some embodiments of the invention the dry solid/semisolid and/or the oil phase may dissolve/mix/blend.

In some embodiments of the invention, the ink-image residue may comprise one or more ingredients of the mixture, for example, at least one liquid oil originated from the hydrophilic treatment formulation and/or at least one solid/semisolid ingredient.

In some embodiments of the invention, the ink-image residue is free of aggregates.

In a further one of its aspects the present invention provides a method of indirect printing comprising:
a. providing an intermediate transfer member (ITM) comprising a silicone-based release layer surface that is sufficiently hydrophilic to satisfy at least one of the following properties:

(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°;
b. providing a mixture of the invention, including a hydrophilic treatment formulation comprising:
i. a liquid containing water, the liquid containing water making up between about 5% to about 97.5%, by weight, (at times between about 5% to about 95%, by weight) of the hydrophilic treatment formulation;
ii. at least one first non-ionic surfactant (e.g., having a solubility in water of at least about 7%, at 25° C.), optionally wherein the first non-ionic surfactant making up between about 2.5% to about 95%, by weight, (at times between about 5% to about 95%, by weight) of the hydrophilic treatment formulation;
wherein the hydrophilic treatment formulation optionally further comprises one or more of:
iii. at least one second non-ionic surfactant (e.g., having a solubility in water of at least 1%, at 25° C.);
iv. at least one non-polymeric humectant;
v. at least one wetting agent optionally being a first water-soluble polymeric wetting agent; and
vi. at least one antibacterial agent;
wherein the hydrophilic treatment formulation is devoid of a second water-soluble polymer (e.g., being a cohesive substance and/or a cohesion inducing substance), the second water-soluble polymer being different from the first water-soluble polymeric wetting agent; and wherein the hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight;
c. applying the mixture to the silicone-based release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. drying the wet treatment layer (e.g., by keeping the ITM at a temperature sufficient to dry the wet treatment layer for example 90° C. to 130° C. and/or by subjecting the wet treatment layer to a drying process) to thereby form a dried non-cohesive treatment layer from the wet treatment layer on the silicone-based release layer surface, the dried non-cohesive treatment layer optionally having a thickness of at least about 20 nm and at most about 500 nm (at times at most about 450, 400, 350, 300, 250 or 200 nm);
e. depositing droplets of an aqueous ink, the aqueous ink comprising at least one binder and at least one colorant, onto at least a region of the dried non-cohesive treatment layer, to form an ink image on the release layer surface of the silicone-based release layer surface;
f. drying the ink image to leave an ink-image residue on the silicone-based release layer surface; and
g. transferring the ink-image residue onto a printing substrate by pressured contact between the ITM and the printing substrate.

In yet a further one of its aspects the present invention provides a system for indirect printing, the system comprising:
a. an intermediate transfer member (ITM) comprising a release layer surface;
b. a quantity of the liquid hydrophilic treatment formulation and of the liquid surfactant additive of the invention;
C. a treatment station for applying a mixture of the liquid hydrophilic treatment formulation and the liquid surfactant additive to the release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. means for subjecting the wet treatment layer to a drying process to form a dried non-cohesive sweating treatment layer from the wet treatment layer on the ITM release layer surface, the dried non-cohesive sweating treatment layer optionally having a thickness of at least about 20 nm and at most about 500 nm (at times at most about 450, 400, 350, 300, 250 or 200 nm);
e. at least one ink jet nozzle positioned proximate the intermediate transfer member and configured for jetting aqueous ink droplets, comprising at least one binder and at least one colorant, onto at least a region of the dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

In some embodiments of the invention, the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

In some embodiments the system of the invention is configured for preforming the method of the invention.

Yet, in a further one of its aspects the present invention provides a system for indirect printing, the system comprising:
a. an intermediate transfer member (ITM) comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°;
b. a quantity of a mixture including a liquid surfactant additive and a liquid hydrophilic treatment formulation, the liquid hydrophilic treatment formulation comprising:
i. a liquid containing water, the liquid containing water making up between about 5% to about 97.5%, by weight, (at times between about 5% to about 95%, by weight) of the hydrophilic treatment formulation;
ii. at least one first non-ionic surfactant (e.g., having a solubility in water of at least about 7%, at 25° C.), optionally wherein the first non-ionic surfactant making up between about 2.5% to about 95%, by weight, (at times between about 5% to about 95%, by weight) of the hydrophilic treatment formulation;
wherein the hydrophilic treatment formulation optionally further comprises one or more of:
iii. at least one second non-ionic surfactant (e.g., having a solubility in water of at least 1%, at 25° C.);
iv. at least one non-polymeric humectant;
v. at least one wetting agent optionally being a first water-soluble polymeric wetting agent; and
vi. at least one antibacterial agent;
wherein the liquid hydrophilic treatment formulation is devoid of a second water-soluble polymer (e.g., being a cohesive substance and/or a cohesion inducing substance), the second water-soluble polymer being different from the first water-soluble polymeric wetting agent; and
wherein the liquid hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight;
c. a treatment station for applying the mixture to the silicone-based release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. means for subjecting the wet treatment layer to a drying process to form a dried non-cohesive treatment layer from the wet treatment layer on the silicone-based release layer surface, the dried non-cohesive treatment layer optionally having a thickness of at least about 20 nm and at most about 500 nm (at times at most about 450, 400, 350, 300, 250 or 200 nm);
e. at least one ink jet nozzle positioned proximate the intermediate transfer member and configured for jetting aqueous ink droplets, comprising at least one binder and at least one colorant, onto at least a region of the dried non-cohesive treatment layer formed on the intermediate transfer member;
f. a drying station for drying the ink on the dried non-cohesive treatment layer formed on the intermediate transfer member to produce an ink-image residue on the silicone-based release layer surface; and
g. an impression station for transferring the ink-image residue onto a printing substrate by pressured contact between the ITM and the printing substrate.

In yet a further one of its aspects the present invention provides a printed article comprising:
(i) a substrate;
(ii) one or more dry ink dots fixedly adhered to at least a region of a surface of the substrate,
wherein the one or more dry ink dots comprise at least one binder, at least one colorant and one or more of non-volatile ingredients of the mixture of the invention.

In some embodiments of the invention, the printed article is devoid of ingredients that the mixture is devoid/free of, as detailed herein above and below.

In some embodiments of the invention, in the printed article the dry one or more ink dots are further covered with a dry non-cohesive layer (which may be a sweating layer) comprising one or more of the non-volatile ingredients of the mixture.

In some embodiments of the invention, in the printed article, non printed regions of the substrate are covered with a dry non-cohesive sweating layer comprising one or more of the non-volatile ingredients of the mixture.

In some embodiments, the printed article of the invention is produced/producible according to the method of the invention.

Yet, in a further one of its aspects the present invention provides an intermediate transfer member comprising a release layer surface, wherein the surface is substantially covered with a dry non-cohesive sweating layer comprising one or more of the non-volatile ingredients of the mixture of the invention, and optionally wherein the thickness of the dry non-cohesive sweating layer being of at least about 20 nm and at most about 500 nm (at times at most about 450, 400, 350, 300, 250 or 200 nm).

In some embodiments, the dry non-cohesive sweating layer covers at least 50% or at least 75% or at least 90% or at least 95% at least 95% or at least 99% or 100% of the intermediate transfer member release layer surface.

In another one of its aspects the present invention provides an intermediate transfer member comprising a release layer surface, wherein the surface is substantially covered with the mixture of the invention.

In a further one of its aspects the present invention provides an intermediate transfer member comprising a release layer surface, wherein the surface is substantially covered with the mixture of the present invention, and wherein when the intermediate transfer member is at a temperature being of between about 90° C. to about 130° C. (inclusive), a dried non-cohesive sweating treatment layer is form thereon, optionally wherein the thickness of the dry non-cohesive sweating layer being of at least about 20 nm and at most about 500 nm.

In some embodiments of the invention, the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

In some embodiments of the invention the wet treatment layer optionally has a thickness of at most about 5.0 μm, at times of at most about 4.5, 4.0, 3.5, 3.0, 2.5, 2.0, 1.5 or 1.0 μm, and the dried non-cohesive (e.g., sweating) treatment layer optionally has a thickness of at least about 20 nm and at most about 500 nm, at times at most about 450, 400, 350, 300, 250 or 200 nm. Any combination between the aforementioned values is within the scope of the present invention.

In some embodiments of the invention the wet treatment layer has a thickness of about 1.0 μm and the dried non-cohesive (e.g., sweating) treatment layer has a thickness of about 350 nm.

Yet, in a further one of its aspects the present invention provides an intermediate transfer member comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°,
wherein the surface is substantially covered with a dry non-cohesive layer (non-film layer) comprising one or more of the ingredients of the mixture of the present invention, and optionally wherein the thickness of the dry non-cohesive layer (non-film layer) being of at least about 20 nm and at most about 500 nm.

Examples of similar printing processes and systems mutatis mutandis are disclosed in the patent publications to the Applicant WO 2017/208152 (PCT/IB2017/053177) [8] and WO 2013/132418 (PCT/IB2013/051716) [9], which content thereof is incorporated herein by reference.

The mixture, or the hydrophilic treatment formulation thereof, may affect the graininess behaviour of the ink image produced utilizing them.

Graininess (solid-area graininess in the specified color plane) refers to irregular fluctuations of density at a spatial frequency less than a specified tile size.

In some embodiments the mixture, when utilized in the printing process of the invention, provides a graininess behaviour of an ink image at 30-80% of ink coverage which is substantially constant e.g., the graininess at 30% coverage is not more than twice of the graininess at 80% coverage.

In some embodiments the mixture is free of a silicane surfactant and when utilized in the printing process of the invention it provides a graininess behaviour of an ink image at 30-80% of ink coverage with a graininess value at 30% coverage being not more than twice of the graininess values at 80% coverage e.g., compared to a treatment formulation that comprises a silicane surfactant and provides a graininess value at 30% coverage being 4 times or more (e.g., 5, 6 or 7 times more) of the graininess values at 80% coverage.

### Definitions

As used herein the term “dry form” or any lingual variations thereof is envisaged as a form substantially devoid of volatile liquids such as water, VOCs and the like e.g., traces amount of said liquids may be present in the form (for example, at most about 0.1 to about 2%, by weight of the form, at times at most about 0.1 to about 1%, by weight of the form). At times the dry form is completely devoid of volatile liquids such as water VOCs and the like.

As used herein, the term “VOCs” refers to organic compounds that have a high vapor pressure at room temperature. Specifically, to organic compounds that have boiling point which is below the temperature at which the printing process is performed e.g., below between about 90° C. to about 130° C.

Thus, in some embodiments a dry form of the hydrophilic treatment formulation of the invention is substantially devoid of water and VOCs and mainly comprises ingredients which boiling point is above the temperature at which the printing process is performed e.g., above 200° C., at times above 250° C., event at times above 300° C.

In some embodiments the non-volatile liquid oil is substantially devoid of water and VOCs and mainly comprises ingredients which boiling point is above the temperature at which the printing process is performed e.g., above 200° C., at times above 250° C., event at times above 300° C.

As uses herein the phrase “a non-cohesive form of a solid or semisolid material sweated with a non-volatile liquid oil” or any lingual variations thereof is envisaged as a dry form of the hydrophilic treatment formulation of the invention in which the dry treatment formulation forms two phases, a dry solid or semisolid phase and an oily liquid phase, the latter may be comprised of one or more oils and may further comprise traces of water and/or another hydrophilic liquid. The two phases may be completely separated or partly separated. For example, the two phases may form of a dispersion in which the oil phase is mixed within the solid phase or dispersed within the semisolid phase or vise versa.

As uses herein the term “semisolid” is interchangeable with the terms “quasi-solid”, “falsely-solid” or any lingual variations thereof and is referred to the physical term for something whose state lies between a solid and a liquid. While similar to solids in some respects, such as having the ability to support their own weight and hold their shapes, semisolid also shares some properties of liquids, such as conforming in shape to something applying pressure to it and the ability to flow under pressure.

In some embodiments the term semisolid refers to a gel.

In some embodiments the term semisolid refers to a semisolid liquid having a relatively high viscosity being above about 500 cp, at times being between about 500 cp to about 1000 cp.

In some embodiments, when the semisolid is a liquid with relatively high viscosity, a dry form of the hydrophilic treatment formulation of the present invention is envisaged as forming two phases, a semisolid non-volatile liquid phase and an oily non-volatile liquid phase. In some embodiments these two phases may be completely separated. In some embodiments these two phases may be partly separated. In some other embodiments these two phases may be in the form of a dispersion in which one phase is dispersed within the other, depending on the viscosities thereof, content thereof, temperature, time scale and other parameters.

It is noted that the oil liquid may be originated from one or more of the ingredients of the hydrophilic treatment formulation which may be provides in a liquid carrier which comprises one or more oils.

In some embodiments of the invention, the hydrophilic treatment formulation is devoid of a film forming agent.

In some embodiments of the invention, the hydrophilic treatment formulation is substantially devoid of a film forming agent.

As used herein the phrase “substantially devoid of a film forming agent” is envisaged as a case in which the hydrophilic treatment formulations of the invention may comprise to some extent a film forming agent, provided that the film forming agent is present in the formulations at a concentration that does not induce film formation e.g., on the ITM once the hydrophilic treatment formulation is dried thereon, for example, when utilized in the printing methods of the invention.

In some embodiments the film forming agent is a binder e.g., a water-soluble polymeric binder.

As used herein the term “anchoring agent” refers to an agent which enables improved adhesion to a specific surface due to its chemical nature. The anchoring agent may inter-alia serve to improve pinning of the hydrophilic treatment formulation to the ITM and reduce coalescence of the wet treatment coating from the ITM.

As used herein the term “blanket” refers to a flexible transfer member that can be mounted within a printing device to form a belt-like structure on two or more rollers, at least one of which is able to rotate and move the blanket (e.g., by moving the belt thereof) to travel around the rollers.

As used herein the term “image transfer member” or “intermediate transfer member” or “transfer member” refers to the component of a printing system upon which the ink is initially applied by the printing heads, for instance by inkjet heads, and from which the jetted image is subsequently transferred to another substrate or substrates, typically, the final printing substrates.

As used herein, the terms “blanket”, “intermediate transfer member”, ITM are used interchangeably and refer to a flexible member comprising a stack of layers used as an intermediate member configured to receive a wet mixture layer which receives an ink image and to transfer the dried ink image film to a target substrate, as described herein.

As used herein, the terms “ink image” and “image” are interchangeable. At times, said terms refer to an image formed on a blanket and transferred to a target substrate. At times they refer to the printed image on the substrate itself (e.g., a paper, a folding carton, or any suitable flexible package in a form of sheets or continuous web). Thus, these terms should be interpreted in the context of the text in which they are used.

As used herein, the term “run” refers to a length or segment of a blanket between any two given rollers over which the blanket is guided.

Unless otherwise stated, the term “concentration” refers to a w/w—i.e., a weight of a component/ingredient of a formulation per total weight of the formulation in its wet form, prior to drying.

As used herein the term “receding contact angle” or “RCA”, refers to a receding contact angle as measured using a Dataphysics OCA15 Pro Contact Angle measuring device, or a comparable Video-Based Optical Contact Angle Measuring System, using the Drop Shape Method. The analogous “advancing contact angle”, or “ACA”, refers to an advancing contact angle measured substantially in the same fashion.

As used herein the term “dynamic contact angle” or “DCA”, refers to a dynamic contact angle as measured using a Dataphysics OCA15 Pro Contact Angle measuring device, or a comparable Video-Based Optical Contact Angle Measuring System, using the method elaborated by Dr. Roger P. Woodward (in “Contact Angle Measurements Using the Drop Shape Method”, inter alia, www.firsttenangstroms.com/pdfdocs/CAPaper.pdf), at ambient temperatures.

As used herein the term ‘Static surface tension’ refers to the static surface tension at 25° C. and atmospheric pressure.

In some embodiments, the term ‘thickness’ of a wet layer is defined as follows. When a volume of material vol covers a surface area of a surface having an area SA with a wet layer—the thickness of the wet layer is assumed to be vol/SA.

In some embodiments, the term ‘thickness’ of a dry layer is defined as follows. When a volume of material vol that is x % liquid, by weight, wets or covers a surface area SA of a surface, and all the liquid is evaporated away to convert the wet layer into a dry layer, a thickness of the dry layer is assumed to be:

vol/pwet layer (100−x)/(SA·ρ_{dry layer})
where ρ_{wet layer} is the specific gravity of the wet layer and ρ_{dry layer} is the specific gravity of the dry layer.

In some embodiments, the term ‘thickness’ of a dry layer is a total thickness of both the solid (or semisolid) material and the non-volatile oil.

In some embodiments of the invention, the hydrophilic treatment formulations are applied onto the ITM to form a continuous wet later. As used herein the term ‘continuous wet layer’ or any lingual variations thereof refers to a continuous wet layer that covers a convex region without any bare sub-regions within a perimeter of the convex region.

In some embodiments of the invention, the dry hydrophilic treatment formulations onto the ITM form a continuous thin dried layer, in particular a non-cohesive layer. As used herein the term ‘continuous thin dried layer’ or any lingual variations thereof refers to a continuous dried layer that covers a convex region without any discontinuities within a perimeter of the convex region.

As used herein the term ‘cohesive substance’ refers to a substance that a construct comprising thereof (e.g., a film) stay together when peeled away from a surface to which it is adhered. As used herein the term ‘cohesive inducing substance’ refers to a substance that induces such a behavior. As used herein the term “non-cohesive layer” refers to a layer that illustrates no cohesive behavior. The non-cohesive layer is different from a ‘cohesive film’, the latter retains its structural integrity and is peeled as a skin.

As used herein the terms “hydrophobicity” and “hydrophilicity” and the like, may be used in a relative sense, and not necessarily in an absolute sense.

As used herein the term ‘(treatment) formulation’ is meant that the formulation is for use with an intermediate transfer member of a printing system i.e., for use in treating a release surface of an ITM with said formulation e.g., as herein described and exemplified.

Unless stated otherwise, physical properties of a liquid (e.g. treatment formulation) such as viscosity and surface tension, refer to the properties at 25° C.

As used herein, unless stated otherwise, a ‘total percent solids’ of a liquid composition is calculated by multiplying 100 times the weight of residue, after complete drying at 25° C., divided by the weight of initial liquid composition.

Unless otherwise defined, all technical and scientific terms used herein have the same meaning as commonly understood by one of ordinary skill in the art to which the invention pertains. In case of conflict, the specification, including definitions, will take precedence.

In the description and claims of the present disclosure, each of the verbs, “comprise” “include” and “have”, and conjugates thereof, are used to indicate that the object or objects of the verb are not necessarily a complete listing of members, components, elements, steps or parts of the subject or subjects of the verb. These terms encompass the terms “consisting of” and “consisting essentially of”.

As used herein, the singular form “a”, “an” and “the” include plural references and mean “at least one” or “one or more” unless the context clearly dictates otherwise.

Unless otherwise stated, the use of the expression “and/or” between the last two members of a list of options for selection indicates that a selection of one or more of the listed options is appropriate and may be made.

Unless otherwise stated, adjectives such as “substantially” and “about” that modify a condition or relationship characteristic of a feature or features of an embodiment of the present technology, are to be understood to mean that the condition or characteristic is defined to within tolerances that are acceptable for operation of the embodiment for an application for which it is intended.

At times, the term “about” indicates ±10% of the value it refers to.

An x degrees Celsius evaporation load is defined as follows: x is a positive number. When a solution is y % solids wt/wt and z % liquid wt/wt at x degrees Celsius, the ‘x-degrees Celsius evaporation load’ of the solution is that ratio z/y. The units of ‘evaporation load’ are “weight solvent per weight total solute.” For the present disclosure, evaporation load is always defined at atmospheric pressure. For the present disclosure, a default value of ‘x’ is 60 degrees C.—the term ‘evaporation load’ without a prefix specifying a temperature refers to a 60 degrees Celsius evaporation load at atmospheric pressure.

It is noted that embodiments detailed herein in connection with a certain aspect of the invention are applicable mutatis mutandis to further aspects of the invention.

### EXAMPLES

Reference is now made to the following examples, which together with the above descriptions, illustrate the invention in a non-limiting fashion.

### A. Exemplary ITM (Banket) Release Layer

### List of Materials Used:

| | | CAS | |
|---|---|---|---|
| Ingredient | Supplier | Number | Description |
| DMS-V35 Resin | Gelest | 68083-19-2 | Vinyl terminated polydimethyl |
| | | | siloxane |
| | | | Viscosity 5,000 mPa · s |
| | | | MW ~49,500 |
| | | | Vinyl ~0.018-0.05 mmol/g |
| VQM-146 Resin | Gelest | 68584-83-8 | 20-25% Vinyl resin in DMS V46 |
| | | | Viscosity 50,000-60,000 mPa · s |
| | | | Vinyl ~0.18-0.23 mmol/g |
| Inhibitor 600 | Evonik | 204-070-5 | Mix of |
| Cure Retardant | | | divinylpolydimethylsiloxane and |
| | | | 2-methylbut-3-yn-2-ol |
| | | | Viscosity 900 mPa · s |
| | | | Vinyl 0.11 mmol/g |
| SIP6831.2 Catalyst | Gelest | 68478-92-2 | Platinum |
| | | | divinyltetramethyldisiloxane |
| | | | Platinum 2.1-2.4% |
| Polymer RV 5000 | Evonik | | Vinyl-functional polydimethyl |
| (XPRV 5000) | | | siloxanes |
| Resin | | | Viscosity 3000 mPa · s |
| | | | Vinyl 0.4 mmol/g |
| Crosslinker 100 | Evonik | | Polydimethyl siloxanes including |
| Crosslinker | | | SiH groups in the polymer chain |
| | | | Hydride 7.8 mmol/g |
| HMS-301 | Gelest | 68037-59-2 | Poly(dimethylsiloxane-co- |
| Crosslinker | | | methyl-hydrosiloxane), |
| | | | trimethylsilyl terminated |
| | | | Hydride 4.2 mmol/g |
| Silsurf A010-D-UP | Siltech | 134180-76-0 | polyether siloxane copolymer |
| Additive | | | |
| SilGrip SR 545 | Momentive | 56275-01-5 | Silicone-based resin containing |
| Functional MQ resin | | | ″MQ″ groups |
| | | | Viscosity 11 mPa · s |
| Aluminized PET | Hanita Ltd. | NR | Aluminized polyester film |
| Skyroll SH 92 | SKC Inc. | NR | Anti-static polyester film |
| Skyroll SH 76 | SKC Inc. | NR | Untreated polyester film |

The carriers used as substrates in the production of the release layer surface include an anti-static polyester film (Examples 1-7).

### Example 1

The ITM release layer of Example 1 had the following composition (wt./wt.):

| Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker | 12 |
| HMS-301 | |

The release layer was prepared substantially as described in the present blanket preparation procedure, provided below.

### Blanket Preparation Procedure (for Release Layers Cured Against a Carrier Surface)

All components of the release layer formulation were thoroughly mixed together. The desired thickness of the incipient release layer was coated on a PET sheet, using a rod/knife (other coating methods may also be used), followed by curing for 3 minutes at 150° C. Subsequently, Siloprene LSR 2530 was coated on top of the release layer, using a knife, to achieve a desired thickness. Curing was then performed at 150° C. for 3 minutes. An additional layer of Siloprene LSR 2530 was then coated on top of the previous (cured) silicone layer, and fiberglass fabric was incorporated into this wet, fresh layer such that wet silicone penetrated into the fabric structure. Curing was then performed at 150° C. for 3 minutes. A final layer of Siloprene LSR 2530 was then coated onto the fiberglass fabric and, once again, curing was performed at 150° C. for 3 minutes. The integral blanket structure was then cooled to room temperature and the PET was removed.

### Example 2

The ITM release layer of Example 2 has the following composition:

| Component Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker HMS-301 | 12 |
| Silsurf A010-D-UP | 5 |

The blanket was prepared substantially as described in Example 1.

### Example 3

The ITM release layer of Example 3 has the following composition:

| Component Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker 100 | 6.5 |
| Silsurf A010-D-UP | 5 |

The blanket was prepared substantially as described in Example 1.

### Example 4

The ITM release layer of Example 4 has the following composition:

| Component Name | Parts |
|---|---|
| DMS-V35 | 100 |
| VQM-146 | 40 |
| Inhibitor 600 | 3 |
| SIP6831.2 | 0.1 |
| Crosslinker HMS-301 | 5 |

The blanket was prepared substantially as described in Example 1.

### Example 5

The ITM release layer of Example 5 was prepared from Silopren® LSR 2530 (Momentive Performance Materials Inc., Waterford, NY), a two-component liquid silicone rubber, in which the two components are mixed at a 1:1 ratio. The blanket was prepared substantially as described in Example 1.

### Example 6

The ITM release layer of Example 6 has a composition that is substantially identical to that of Example 4, but includes SR545 (Momentive Performance Materials Inc., Waterford, NY), a commercially available silicone-based resin containing polar groups. The polar groups are of the “MQ” type, where “M” represents Me₃SiO and “Q” represents SiO₄. The full composition is provided below:

| Component Name | Parts |
|---|---|
| DMS-V35 | 100 |
| VQM-146 | 40 |
| SR545 | 5 |
| Inhibitor 600 | 3 |
| SIP6831.2 | 0.1 |
| Crosslinker HMS-301 | 5 |

The blanket was prepared substantially as described in Example 1.

### Example 7

The ITM release layer of Example 7 has a composition that is substantially identical to that of Example 6, but includes polymer RV 5000, which includes vinyl-functional polydimethyl siloxanes having a high density of vinyl groups, as described hereinabove. The full composition is provided below:

| Component Name | Parts |
|---|---|
| DMS-V35 | 70 |
| RV 5000 | 30 |
| VQM-146 | 40 |
| Inhibitor 600 | 5 |
| SIP6831.2 | 0.1 |
| Crosslinker HMS-301 | 12 |
| SR545 | 5 |

The blanket was prepared substantially as described in Example 1.

### B. Hydrophilic Treatment Formulation

List of Materials Used for Treatments below:

| | | | | Chemical |
|---|---|---|---|---|
| | | | | Name/ |
| Ingredient | Supplier | Function | Class | Description |
| Methocel ® K-3 | DOW | binder | Hydroxymethyl | hydroxypropyl substituted |
| Premium LV | | | propylcellulose | methyl cellulose, |
| | | | | 19-24% methoxyl |
| | | | | substitution, |
| | | | | 7-12% hydroxypropyl |
| | | | | substitution, |
| | | | | 2.4-3.6 cps viscosity |
| Byk ® Ipx 23289 | BYK ® | surfactant | Silicone surfactant | Polyether-modified |
| | | | | polydimethylsiloxane |
| Loxanol ® PL | BASF | wetting agent | polyethylenimine | Polypropylene |
| 5060 | Australia | | | glycol alkyl phenyl |
| | Ltd. | | | ether (CAS Number: |
| | | | | 9064-13-5) |
| Pluronic 10R5 | BASF | plasticizer/ | non-ionic | Poly(propylene glycol)- |
| | | surfactant | surfactant | block-poly(ethylene |
| | | | | glycol)-block-poly |
| | | | | (propylene glycol) |
| | | | | (CAS Number: |
| | | | | 9003-11-6) |
| Disponil APG | BASF | surfactant | non-ionic | Aqueous solution |
| 215 | | | surfactant | based on: Alkyl |
| | | | | polyglycoside C8-10 |
| | | | | (CAS Number: |
| | | | | 68515-73-1) |
| Dynol 360 | Evonic | surfactant | non-ionic | Thioether |
| | | | surfactant | (CAS Number: |
| | | | | 928768-73-4) |
| Dynol 604 | Evonic | surfactant | non-ionic | Ethoxylated |
| | | | surfactant | Acetylenic Diols |
| | | | | (CAS Number: |
| | | | | 169117-72-0) |
| Surfinol 465 | Evonic | surfactant | non-ionic | Ethoxylated |
| | | | surfactant | 2,4,7,9-tetramethyl |
| | | | | 5 decyn-4,7-diol |
| | | | | (CAS Number: |
| | | | | 9014-85-1) |
| Sugar | | | Humectant | |
| (disaccharide) | | | | |
| Tween ® 20 | Sigma- | surfactant | non-ionic | PEG-20 sorbitan |
| | Aldrich | | surfactant | monolaurate |
| Mergal ® K12N | Troy | antimicrobial | | 2-bromo-2-nitro- |
| | International | | | 1,3-propanediol |
| water | | | | DI water |

77

The following hydrophilic treatment formulations were prepared:

### Example 8A—Formulation A—Formulation Usable as Part of a Kit of the Invention—the Formulation being Devoid of a Cohesive Water-Soluble Polymer

| | | Concentration |
|---|---|---|
| | Components | w/w % |
| | BYK 23289 | 3.82 |
| | Loxanol MI 6730 | 0.2 |
| | Sugar | 9.60 |
| | Tween 20 | 24.01 |
| | Mergal K12N | 0.20 |
| | Water | 62.17 |
| % solids | | 37.83% |

### Example 8B—Formulation C—a Formulation Useful in a Kit of the Invention—the Formulation being Devoid of a Cohesive Water-Soluble Polymer as Well as a Silicon Containing Surfactant

| | | Concentration |
|---|---|---|
| | Components | w/w % |
| | Pluronic 10R5 | 8.1 |
| | Disponil APG 215 | 11.6 |
| | Loxanol MI 6730 | 0.2 |
| | Sugar | 7.7 |
| | Dynol 360 | 3.90 |
| | Tween 20 | 2.5 |
| | Mergal K12N | 0.20 |
| | Water | 65.8 |
| % solids | | 34.2% |

Furter formulations based on the above formulation were prepared as follows:
Formulation C without Dynol 360 (Formulation E);
Formulation C with 14.7 w/w % Pluronic 10R5, 8.8 w/w % Disponil APG 215, and without Dynol 360 (Formulation F).

### Example 8C—Formulation D—a Formulation Useful in a Kit of the Invention—the Formulation being Devoid of a Cohesive Water-Soluble Polymer as Well as a Silicon Containing Surfactant

| | | Concentration |
|---|---|---|
| | Components | w/w % |
| | Pluronic 10R5 | 14.7 |
| | Disponil APG 215 | 8.8 |
| | Loxanol MI 6730 | 0.29 |
| | Sugar | 8.8 |
| | Tween 20 | 5.9 |
| | Mergal K12N | 0.20 |
| | Water | 61.31 |
| % solids | | 38.51% |

### Example 8D—Further Formulations Useful in Kits of the Invention—the Formulations being Devoid of a Cohesive Water-Soluble Polymer as Well as a Silicon Containing Surfactant

Further formulations were prepared at various concentration ranges of the components as noted below:

| | | Concentration |
|---|---|---|
| | Components | w/w % |
| | Pluronic 10R5 | 8.0-15.0 |
| | Disponil APG 215 | 8.0-11.6 |
| | Loxanol MI 6730 | 0.2 |
| | Sugar | 7.7 |
| | Dynol 360 | 0-5 |
| | Tween 20 | 2.5 |
| | Mergal K12N | 0.20 |
| | Water | Complete to 100% total |
| % solids | | ~29-34% |

### Example 9—Testing the Resolution of the Printed Image and the Ink Dot Size for Different Quantities of Liquid Surfactant Additive in the Mixture or Kit of the Invention

The resolution of printed images and the ink drop diameter printed on a coated paper (burgo 130 gsm) utilizing black ink in printing processes that utilized mixtures formed of kits of the present invention were measured and compared.

Each of the mixtures included a fixed quantity of a hydrophilic treatment formulation as listed herein:

| | | Concentration |
|---|---|---|
| | Components | w/w % |
| | Pluronic 10R5 | 10.4 |
| | Disponil APG 215 | 14.85 |
| | Loxanol MI 6730 | 0.4 |
| | Sugar | 9.9 |
| | Tween 20 | 3.2 |
| | Mergal K12N | 0.20 |
| | Water | Complete to 100% total |
| % solids | | 38.75 |

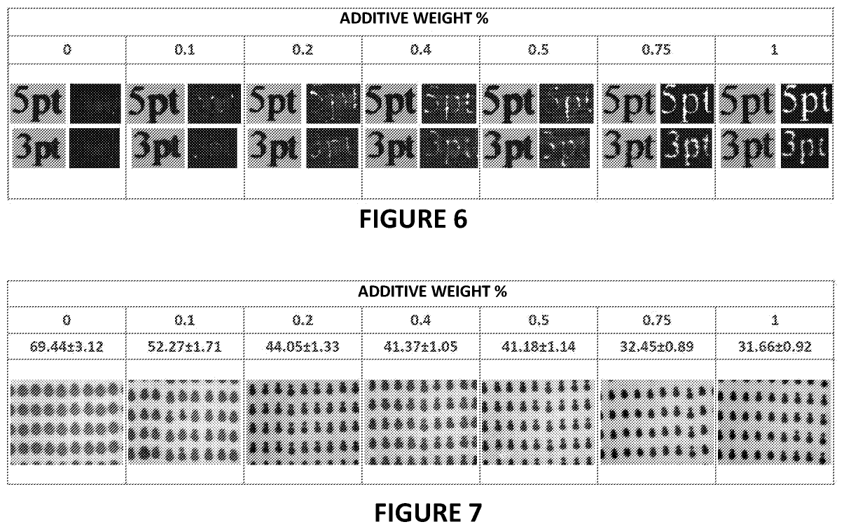

Each of the mixtures included a different quantity of a surfactant additive, forming a different weight % of the mixture, as shown in FIGS. 6 to 8.

The fixed quantity of the liquid hydrophilic treatment formulation was approximately 0.5 g/m² per sheet printed using the mixture. The different quantities of the surfactant additive were in the range of 0-0.005 g/m² per sheet printed using the mixture.

The printing was carried out substantially in accordance with the method described hereinabove with respect to FIG. 3.

As seen in FIG. 6, the greater the quantity of the surfactant additive used in the mixture, the clearer the print, both when printing black characters on white paper, and when forming the letters as the blank spaces surrounded by black print. Stated differently, the greater the weight percentage of the surfactant additive, the higher the resolution of the printed material.

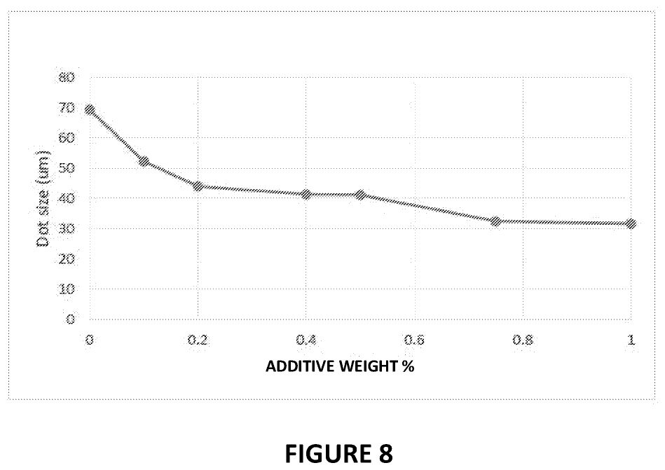

Turning to FIGS. 7 and 8, the dot sizes are shown in μm, and it is clear that the greater the quantity of the surfactant additive used in the mixture, the smaller the dot size formed on the printed substrate.

Consequently it would be understood by those of skill in the art that the quantity of surfactant additive added to the formulation can be used to control, or modulate, the resulting resolution of the printed image, for example in accordance with the requirements for that image.

### Example 10—Testing the Resolution of the Printed Image and the Ink Dot Size for Different Quantities of Liquid Surfactant Additive in the Mixture or Kit of the Invention

The experiment of Example 9 was repeated using the same ink, paper, liquid surfactant additive, and proportions of the liquid surfactant additive in the tested mixtures, but using a different liquid hydrophilic treatment composition. The hydrophilic treatment composition used in the present example was as follows:

| | | Concentration |
|---|---|---|
| | Components | w/w % |
| | BYK 23289 | 3.82 |
| | Loxanol MI 6730 | 0.2 |
| | Sugar | 9.60 |
| | Tween 20 | 24.01 |
| | Mergal K12N | 0.20 |
| | Water | 62.17 |
| % solids | | 37.83% |

The fixed quantity of the liquid hydrophilic treatment formulation was approximately 0.5 g/m² per sheet printed using the mixture. The different quantities of the surfactant additive were in the range of 0-0.005 g/m² per sheet printed using the mixture.

The printing was carried out substantially in accordance with the method described hereinabove with respect to FIG. 3.

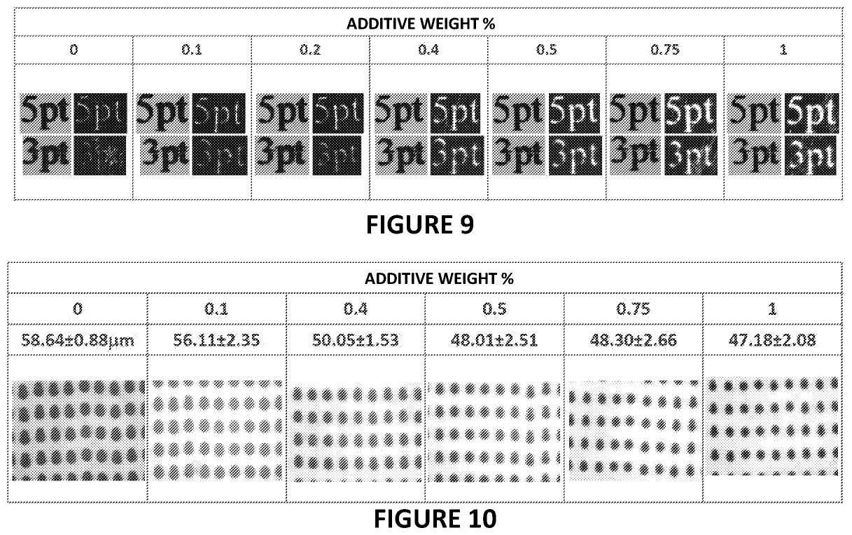

Similarly to the results shown in FIG. 6, also in FIG. 9 which shows the results of the present example, the greater the quantity of the surfactant additive used in the mixture, the clearer the print, both when printing black characters on white paper, and when forming the letters as the blank spaces surrounded by black print. Stated differently, the greater the weight percentage of the surfactant additive, the higher the resolution of the printed material.

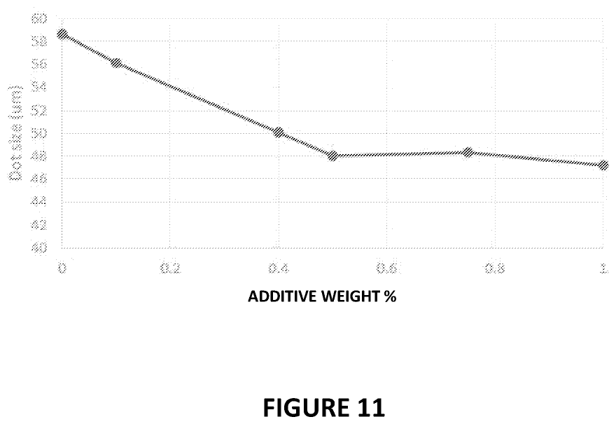

Further, as seen in FIGS. 10 and 11, the dot sizes are shown in μm, and it is clear that the greater the quantity of the surfactant additive used in the mixture, the smaller the dot size formed on the printed substrate.

Consequently it would be understood by those of skill in the art that the quantity of surfactant additive added to the formulation can be used to control, or modulate, the resulting resolution of the printed image, for example in accordance with the requirements for that image, for multiple different types of the hydrophilic treatment formulation.

### C. Exemplary Ink Composition

### Preparation of Pigments

Pigments used in the examples described below are generally supplied with initial particle size of a few micrometers. Such pigments were ground to submicron range in presence of the dispersing agent, the two materials being fed to the milling device (bead mill) as an aqueous mixture. The progress of milling was controlled on the basis of particle size measurements (for example, a Malvern or Nanosizer instrument). The milling was stopped when the average particle size (d_{V}50) reached 70 to 100 nm.

In the present example, the preparation of an ink composition is described: Heliogen® Blue D7079 was milled with Disperbyk® 190, as described, and the materials were mixed in the following proportion:

| Heliogen ® Blue D7079 | 30 | g |
|---|---|---|
| Disperbyk ® 190 (40%) | 30 | g |
| Water | 140 | g |
| ===========================A | | |
| Total | 200 | g |

The milled concentrate, now having a D_{V}50 of less than 100 nm, typically between 70 and 100 nm, and was further diluted with 50 g water and extracted from the milling device at ca. 12 wt. % pigment concentration. The millbase concentrate was further processed as below described for the preparation of an ink composition.

In a first stage, 2.4 g of sodium dodecanoate were added to 200 g of the millbase concentrate to yield a millbase. The mixture was stirred to homogeneity (5′ magnetic stirrer at 50 rpm) and incubated at 60° C. for 1 day. The mixture was then left to cool down to ambient temperature.

In a second stage, ink ingredients were added to the millbase as follows:

| | | |
|---|---|---|
| Millbase Concentrate | 202.4 | g |
| (from stage 1) | | |
| Joncryl ® 538 (46.5%) | 154.8 | g |
| BYK ® 349 | 5 | g |
| BYK ® 333 | 2 | g |
| Propylene Glycol | 240 | g |
| Water | 595.8 | g |
| Total | 1200 | g |

The mixture was stirred for 30 minutes at ambient temperature, resulting in an ink-jettable ink composition having a viscosity of less than 10 cP.

Further inks were tested such as yellow, magenta, cyan, black, orange, green and blue.

### ILLUSTRATIVE EMBODIMENTS

The following embodiments are illustrative and not intended to limit the claimed subject matter. Further, the embodiments detailed herein above in connection with other aspects of the invention are considered relevant also to the embodiments detailed herein below mutatis mutandis.

1. A kit for use with an intermediate transfer member (ITM) of a printing system, the kit comprising:
a) a liquid hydrophilic treatment formulation disposed in a first container, wherein a dry form of the hydrophilic treatment formulation is a non-cohesive form of a solid or semisolid material sweated with a non-volatile liquid oil;
b) a liquid surfactant additive disposed in a second container, such that the liquid hydrophobic treatment formulation is separate from the liquid surfactant additive,
wherein the liquid hydrophilic treatment formulation is devoid of the liquid surfactant additive,
wherein application of an aqueous ink onto an at least partially dry form of the hydrophilic treatment formulation applied to the ITM forms ink dots having a first diameter,
wherein application of the aqueous ink onto at least partially dry form of a mixture of a first quantity of the hydrophilic treatment formulation and a second quantity of the surfactant additive, the second quantity being smaller than the first quantity, the mixture applied to the ITM, forms ink dots having a second diameter, smaller than the first diameter, and
wherein the second diameter is configurable by modification of a ratio between the first quantity of the liquid hydrophilic treatment formulation in the mixture and the second quantity of the liquid surfactant additive in the mixture.

2. A kit for use with an intermediate transfer member (ITM) of a printing system, the kit comprising:
a) a liquid hydrophilic treatment formulation disposed in a first container, wherein a dry form of the hydrophilic treatment formulation is a non-cohesive form of a solid or semisolid material sweated with a non-volatile liquid oil;
b) a liquid surfactant additive disposed in a second container, such that the liquid hydrophobic treatment formulation is separate from the liquid surfactant additive,
wherein the liquid hydrophilic treatment formulation is devoid of the liquid surfactant additive,
wherein a mixture of a first quantity of the hydrophilic treatment formulation and a second quantity of the surfactant additive, retains at least one of the following properties of the liquid hydrophilic treatment formulation in the first container:
   solubility;
   clarity;
   color;
   reactivity with an aqueous ink used for printing on the ITM of the printing system;
   ability to be applied to the ITM;
   drying properties;
   ability to form an ink film following deposit of aqueous ink onto a layer of the mixture;
   mechanical properties; and
   ability to be covered with a coating layer.

3. The kit of embodiment 2, wherein the mixture is different, in at least one of the following properties, from the liquid hydrophilic treatment formulation in the first container:
surface tension;
wetting; and
surface energy.

4. The kit of embodiment 3, wherein the mixture has a lower surface tension than the liquid hydrophilic treatment formulation in the first container.

5. The kit of embodiment 3 or embodiment 4, wherein the mixture has a lower surface energy than the liquid hydrophilic treatment formulation in the first container.

6. The kit of any one of embodiments 3 to 5, wherein the mixture has a lower wetting property than the liquid hydrophilic treatment formulation in the first container.

7. The kit of any one of embodiments 2 to 6, wherein the mixture retains the solubility of the liquid hydrophilic treatment formulation.

8. The kit of any one of embodiments 2 to 7, wherein the mixture retains the clarity of the liquid hydrophilic treatment formulation.

9. The kit of any one of embodiments 2 to 8, wherein the mixture retains the color of the liquid hydrophilic treatment formulation.

10. The kit of any one of embodiments 2 to 9, wherein the mixture retains a reactivity of the liquid hydrophilic treatment formulation with an aqueous ink used for printing on the ITM of the printing system.

11. The kit of any one of embodiments 2 to 10, wherein the mixture retains an ability of the liquid hydrophilic treatment formulation to be applied to the ITM of the printing system.

12. The kit of any one of embodiments 2 to 11, wherein the mixture retains drying properties of the liquid hydrophilic treatment formulation.

13. The kit of any one of embodiments 2 to 12, wherein the mixture retains an ability of the liquid hydrophilic treatment formulation to form an ink film following deposit of aqueous ink used for printing in the printing system onto a layer of the mixture.

14. The kit of any one of embodiments 2 to 13, wherein the mixture retains mechanical properties of the liquid hydrophilic treatment formulation.

15. The kit of any one of embodiments 2 to 14, wherein the mixture retains an ability of the liquid hydrophilic treatment formulation to be covered with a coating layer.

16. The kit of any one of embodiments 2 to 15, wherein application of an aqueous ink onto an at least partially dry form of the hydrophilic treatment formulation, applied to the ITM, forms ink dots having a first diameter,
wherein application of the aqueous ink onto at least partially dry form of a mixture of a first quantity of the hydrophilic treatment formulation and a second quantity of the surfactant additive applied to the ITM, the second quantity being smaller than the first quantity, forms ink dots having a second diameter, smaller than the first diameter, and
wherein the second diameter is configurable by modification of a ratio between the first quantity of the liquid hydrophilic treatment formulation in the mixture and the second quantity of the liquid surfactant additive in the mixture.

17. The kit of any one of embodiments 1 to 16, wherein the first container is a sealed container.

18. The kit of any one of embodiments 1 to 17, wherein the second container is a sealed container.

19. The kit of any one of embodiments 1 to 18 wherein the first container is separate and distinct from the second container.

20. The kit of any one of embodiments 1 to 19, wherein a volume of the first container is at least twice, at least three times, at least five times, or at least ten times as large as a volume of the second container.

21. The kit of any one of embodiments 1 to 20, wherein the first quantity is equal to the volume of the first container.

22. The kit of any one of embodiments 1 to 21, wherein the second quantity is equal to the volume of the second container.

23. The kit of any one of embodiments 1 to 21, wherein the second container comprises multiple second containers, each holding a different volume of the liquid surfactant additive, and wherein the second quantity is equal to the entire volume of one of the multiple second containers.

24. The kit of any one of embodiments 1 to 23, wherein the second quantity is at most 2% by weight of the first quantity.

25. The kit of any one of embodiments 1 to 23, wherein the second quantity is at most 1% by weight of the first quantity.

26. The kit of any one of embodiments 1 to 23, wherein the second quantity is at most 0.5% by weight of the first quantity.

27. The kit of any one of embodiments 1 to 23, wherein the second quantity is at most 0.25% by weight of the first quantity.

28. The kit of any one of embodiments 1 to 28, wherein the second quantity is at least 0.05% by weight of the first quantity.

29. The kit of any one of embodiments 1 to 28, wherein the second quantity is at least 0.1% by weight of the first quantity.

30. The kit of any one of embodiments 1 to 23, wherein, in the mixture of the first quantity of the hydrophilic treatment formulation and the second quantity of the liquid surfactant additive, the liquid surfactant additives is in the range of 0.1% to 0.5% by weight of the mixture.

31. The kit of any one of embodiments 1 to 30, wherein the first quantity is in the range of 250 kg to 300 kg.

32. The kit of any one of embodiments 1 to 31, wherein the second quantity is in the range of 0.5 kg to 1.0 kg.

33. The kit of embodiment 1 or embodiment 16, wherein a range of the ratio of the first diameter to the second diameter is in the range of 1.05:1 to 4:1.

34. The kit of any one of embodiments 1 to 33, wherein the hydrophilic treatment formulation comprises:
i. a liquid containing water, the liquid containing water making up between about 5% to about 97.5%, by weight, of the hydrophilic treatment formulation;
i. at least one first non-ionic surfactant;
wherein the hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of the hydrophilic treatment formulation is a non-cohesive form of a solid or semisolid material sweated with a non-volatile liquid oil.

35. The kit of any one of embodiments 1 to 34, wherein the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

36. The kit of embodiment 34 or embodiment 35, wherein the hydrophilic treatment formulation has the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight.

37. The kit of any one of embodiments 34 to 36, wherein the hydrophilic treatment formulation is devoid of a second water-soluble polymer, the second water-soluble polymer being different from the first water-soluble polymeric wetting agent and wherein the second water-soluble polymer is a cohesive substance and/or a cohesion inducing substance.

38. The kit of embodiment 37, wherein the second water-soluble polymer is a water absorbing polymeric agent.

39. The kit of embodiment 37, wherein the hydrophilic treatment formulation is substantially devoid of a further cohesive substance and/or a cohesion inducing substance.

40. The kit of embodiment 37, wherein the kit is devoid of a further cohesive substance and/or a cohesion inducing substance.

41. The kit of any one of embodiments 1 to 40, wherein the hydrophilic treatment formulation is substantially devoid of a film forming agent.

42. The kit of any one of embodiments 1 to 40, wherein the kit is substantially devoid of a film forming agent.

43. The kit of any one of embodiments 35 to 42, wherein the liquid containing water is water only or a mixture of water and at least one water soluble organic solvent.

44. The kit of any one of embodiments 35 to 43, wherein the hydrophilic treatment formulation further comprises at least one first water-soluble polymeric wetting agent.

45. The kit of any one of embodiments 35 to 44, wherein the first water-soluble polymeric wetting agent is a multiple charged polymer e.g., a polycation or a polyanion.

46. The kit of embodiment 45, wherein the polycation is selected from the group consisting of polyethyleneimine (PEI), poly(amidoamine) (PAMAM), poly-l-lysine (PLL) and poly(diallyl dimethyl ammonium) (PDDA).

47. The kit of embodiment 45, wherein the polyanion is selected from the group consisting of acrylic polymers, polyacryl amides and poly-DADMAc.

48. The kit of embodiment 45, wherein the first water-soluble polymeric wetting agent is PEI.

49. The kit of any one of embodiments 44 to 48, wherein apart from the first water-soluble polymeric wetting agent and/or the at least one first non-ionic surfactant, the hydrophilic treatment formulation is devoid of a substance with a molecular weight being of about 1300 gr/mol and above.

50. The kit of any one of embodiments 34 to 49, wherein the hydrophilic treatment formulation is further devoid of one or more of an inorganic salt, an inorganic metallic compound, a polyvalent metal ion and a metal ion.

51. The kit of any one of embodiments 34 to 50, wherein the hydrophilic treatment formulation is further devoid of an acid.

52. The kit of any one of embodiments 34 to 51, wherein the hydrophilic treatment formulation is further devoid of a resolubilizing agent.

53. The kit of any one of embodiments 34 to 52, wherein the hydrophilic treatment formulation is devoid of one or more of the ingredients detailed in any one of embodiments 37-40 and embodiments 46-49 or any combination thereof.

54. The kit of any one of embodiments 34 to 53, wherein the total percent solids by weight of the hydrophilic treatment formulation is at least about 5%, or between about 5% to about 95%, in particular between about 27% to about 95%, even more particular between about 35% to about 95%.

55. The kit of any one of embodiments 34 to 54, wherein the hydrophilic treatment formulation has a 60° C. evaporation load of at least about 1.86:1 by weight.

56. The kit of any one of embodiments 34 to 55, wherein the at least one first non-ionic surfactant has a solubility in water of at least about 7%, at 25° C.

57. The kit of any one of embodiments 34 to 56, wherein the at least one first non-ionic surfactant makes up between about 2.5% to about 95%, by weight, of the hydrophilic treatment formulation.

58. The kit of any one of embodiments 34 to 56, wherein the hydrophilic treatment formulation comprises at least two first non-ionic surfactants or at least three first non-ionic surfactants, and wherein a total content of the at least two or at least three first non-ionic surfactants make up between about 2.5% to about 95%, by weight, of the hydrophilic treatment formulation.

59. The kit of any one of embodiments 34 to 58, wherein the at least one first non-ionic surfactant is a silicon containing surfactant.

60. The kit of any one of embodiments 34 to 58, wherein the at least one first non-ionic surfactant is a non-silicon containing surfactant.

61. The kit of any one of embodiments 34 to 55, wherein one or more of the first non-ionic surfactants is a non-silicon containing surfactant.

62. The kit of any one of embodiments 34 to 61, wherein the at least one second non-ionic surfactant has a solubility in water of at least 1%, at 25° C.

63. The kit of any one of embodiments 34 to 62, wherein the at least one second non-ionic surfactant is a silicon containing surfactant.

64. The kit of any one of embodiments 34 to 62, wherein the at least one second non-ionic surfactant is a non-silicon containing surfactant.

65. The kit of any one of embodiments 34 to 64, wherein the second non-ionic surfactant making up at most 10%, by weight of the hydrophilic treatment formulation.

66. The kit of any one of embodiments 34 to 65, wherein the hydrophilic treatment formulation comprises at least two second non-ionic surfactants or at least three second non-ionic surfactants, and wherein a total content of the at least two or at least three second non-ionic surfactants make up at most 10%, by weight of the hydrophilic treatment formulation.

67. The kit of any one of embodiments 34 to 66, wherein one or more of the second non-ionic surfactants is a non-silicon containing surfactant.

68. The kit of any one of embodiments 34 to 67, wherein the hydrophilic treatment formulation further comprises at least one wetting agent, the wetting agent making up at most about 1%, by weight, of the hydrophilic treatment formulation, in particular at most about 0.20%, more particular 0.20% of the hydrophilic treatment formulation.

69. The kit of any one of embodiments 34 to 68, wherein the humectant making up at most about 30%, by weight, of the hydrophilic treatment formulation.

70. The kit of any one of embodiments 34 to 69, wherein the at least one humectant is a non-polymeric humectant.

71. The kit of any one of embodiments 34 to 70, wherein the antibacterial agent making up at most about 1%, by weight, of the hydrophilic treatment formulation.

72. The kit of any one of embodiments 34 to 71, wherein:
the at least one first non-ionic surfactant making up between about 2.5% to about 95%, by weight, of the hydrophilic treatment formulation;
the at least one second non-ionic surfactant making up at most 10%, by weight of the hydrophilic treatment formulation;
the at least one wetting agent making up at most about 1%, by weight, of the hydrophilic treatment formulation, in particular at most about 0.20%, more particular 0.20% of the hydrophilic treatment formulation;
the at least one humectant making up at most about 30%, by weight, of the hydrophilic treatment formulation; and
the at least one antibacterial agent making up at most about 1%, by weight, of the hydrophilic treatment formulation.

73. The kit of any one of embodiments 34 to 72, wherein the hydrophilic treatment formulation is devoid of a silicon surfactant.

74. The kit of any one of embodiments 34 to 73, wherein the ingredients of the hydrophilic treatment formulation are compatible with each other and with the liquid containing water.

75. The kit of any one of embodiments 34 to 74, wherein the hydrophilic treatment formulation is a phase separation and with no sedimentation/precipitation at 25° C.

76. The kit of any one of embodiments 34 to 75 wherein the hydrophilic treatment formulation is a clear colorless solution at 25° C.

77. The kit of any one of embodiments 34 to 76, wherein the ingredients of the hydrophilic treatment formulation do not form aggregates with the colorant of an aqueous ink utilized in a printing system or method.

78. The kit of any one of embodiments 1 to 77, wherein the liquid surfactant additive is a silicone-based surfactant.

79. The kit of any one of embodiments 1 to 77, wherein the liquid surfactant additive is a non-silicone-based surfactant.

80. A method of indirect printing using the kit of any one of embodiments 1 to 79, the method comprising:
a. providing an intermediate transfer member (ITM) comprising a release layer surface;
b. mixing the first quantity of the hydrophilic treatment formulation with the second quantity of the surfactant additive to form the mixture;
c. applying the mixture onto the release layer surface of the ITM to form thereon a wet treatment layer optionally having a thickness of at most about 5.0 μm;
d. at least partially drying the wet treatment layer to thereby form an at least partially dried non-cohesive sweating treatment layer from the wet treatment layer on the ITM release layer surface, the at least partially dried non-cohesive sweating treatment layer optionally having a thickness of at least about 20 nm and at most about 500 nm;
e. depositing droplets of an aqueous ink, onto at least a region of the at least partially dried non-cohesive sweating treatment layer, to form an ink image on the ITM release layer surface;
f. drying the ink image to leave an ink-image residue on the ITM release layer surface; and
g. transferring the ink-image residue onto a printing substrate by pressured contact between the ITM and the printing substrate.

81. The method of embodiment 80, wherein the depositing droplets comprises depositing droplets of an aqueous ink comprising at least one binder and at least one colorant.

82. The method of embodiment 80 or embodiment 81, wherein the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

83. The method of any one of embodiments 80 to 82, wherein the mixture is substantially devoid of a cohesive substance and/or a cohesion inducing substance thereby once the mixture is at least partially dried on the release layer surface of the ITM it does not form a film layer thereon.

84. The method of any one of embodiments 80 to 83, wherein the drying in step (d) is performed at a temperature of between about 90° C. to about 130° C., inclusive.

85. The method of any one of embodiments 80 to 84, wherein the at least partially dried non-cohesive sweating treatment layer is comprised of a solid material or a semisolid material sweated with a non-volatile liquid oil.

86. The method of any one of embodiments 80 to 85, wherein the at least partially dried non-cohesive sweating treatment layer is colorless.

87. The method of any one of embodiments 80 to 86, wherein the ingredients of the hydrophilic treatment formulation do not form aggregates with the colorant of the aqueous ink.

88. The method of any one of embodiments 80 to 87, wherein in step (g), to some extent, the dry non-cohesive sweating treatment layer, in both printed and non-printed regions on the ITM, is transferred to the printing substrate, together with the ink-image residue, leaving a residual dry non-cohesive sweating treatment layer on the ITM or a residual dry non-cohesive non-sweating treatment layer on the ITM.

89. The method of embodiment 88, wherein the method comprises several repeating cycles of steps (c) to (g) (e.g., 1000 cycles), and wherein between each cycle the newly applied mixture in step (c) completely dissolves the residual dry non-cohesive sweating treatment layer or the residual dry non-cohesive non-sweating treatment layer of the previous cycle, thereby no accumulation of the residual layer/s between each of the cycles occurs.

90. The method of any one of embodiments 80 to 89, wherein when the droplets of the aqueous ink are deposited onto the dry non-cohesive sweating treatment layer, a surface of the dry non-cohesive sweating treatment layer, which is in close contact with the aqueous ink, is capable of dissolving into the aqueous ink and/or mix and/or blend with the aqueous ink, optionally forming an intermediate phase comprising one or more ingredients of the mixture and the ink ingredients.

91. The method of any one of embodiments 80 to 90, wherein the ink-image residue further comprises one or more ingredients of the mixture.

92. The method of any one of embodiments 80 to 91, wherein the ink-image residue is free of aggregates.

93. The method of any one of embodiments 80 to 92, further comprising, prior to the mixing, selecting the second quantity of the liquid surfactant based on a required resolution of the print job being printed.

94. The method of embodiment 93, wherein the selecting comprises automatically selecting the second quantity based on the required resolution, and the mixing comprises automatically mixing the selected second quantity with the first quantity to form the mixture.

95. The method of any one of embodiments 80 to 94, wherein the applying of the mixture comprises jetting the mixture onto the release layer surface of the ITM.

96. A system for indirect printing using the kit of any one of embodiments 1 to 79, the system comprising:
a. an intermediate transfer member (ITM) comprising a release layer surface;
b. a mixture of the first quantity of the hydrophilic treatment formulation and the second quantity of the surfactant additive;
c. a treatment station for applying the mixture to the release layer surface of the ITM to form thereon a wet treatment layer optionally having a thickness of at most 5.0 μm;
d. means for subjecting the wet treatment layer to a drying process to form an at least partially dried non-cohesive sweating treatment layer from the wet treatment layer on the ITM release layer surface, the at least partially dried non-cohesive sweating treatment layer optionally having a thickness of at least about 20 nm and at most about 500 nm;
e. at least one ink jet nozzle positioned proximate the intermediate transfer member and configured for jetting aqueous ink droplets, onto at least a region of the at least partially dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

97. The system of embodiment 96, wherein the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

98. The system of embodiment 96 or 97, for preforming the method of any one of embodiments 80 to 95.

99. A printed article comprising:
(i) a substrate;
(ii) one or more dry ink dots fixedly adhered to at least a region of a surface of the substrate,
wherein the one or more dry ink dots comprise at least one binder, at least one colorant and one or more of non-volatile ingredients of the kit of any one of embodiments 1 to 79.

100. The printed article of embodiment 99, wherein the dry one or more ink dots are further covered with a dry non-cohesive sweating layer comprising one or more of the non-volatile ingredients of the kit.

101. The printed article of embodiment 99 or 100, wherein non printed regions of the substrate are covered with a dry non-cohesive sweating layer comprising one or more of the non-volatile ingredients of the kit.

102. The printed article of any one of embodiments 99 to 101, produced according to the method of any one of embodiments 80 to 95.

103. An intermediate transfer member comprising a release layer surface, wherein the surface is substantially covered with a dry non-cohesive sweating layer comprising one or more of the non-volatile ingredients of the hydrophilic treatment formulation and the surfactant additive of the kit of any one of embodiments 1 to 79, and optionally wherein the thickness of the dry non-cohesive sweating layer being of at least about 20 nm and at most about 500 nm.

104. The intermediate transfer member of embodiment 103, wherein the dry non-cohesive sweating layer covers at least 50% or at least 75% or at least 90% or at least 95% at least 95% or at least 99% or 100% of the intermediate transfer member release layer surface.

105. An intermediate transfer member comprising a release layer surface, wherein the surface is substantially covered with a mixture of the first quantity of the hydrophilic treatment formulation and the second quantity of the surfactant additive of the kit of any one of embodiments 1 to 79.

106. An intermediate transfer member comprising a release layer surface, wherein the surface is substantially covered with a mixture of the first quantity of the hydrophilic treatment formulation and the second quantity of the surfactant additive of the kit of any one of embodiments 1 to 79, and wherein when the intermediate transfer member is at a temperature being of between about 90° C. to about 130° C., a dried non-cohesive sweating treatment layer is formed thereon, optionally wherein the thickness of the dry non-cohesive sweating layer being of at least about 20 nm and at most about 500 nm.

107. The intermediate transfer member of any one of embodiments 103 to 106, comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

108. A printing system comprising:
(a) an intermediate transfer member (ITM) comprising an endless belt;
(b) a mixing element adapted to form a mixture from a first quantity of a liquid hydrophilic treatment formulation and a second quantity of a liquid surfactant additive, the second quantity being at most 2% of the first quantity;
(c) a treatment station for applying the mixture to the surface of the ITM to form thereon a wet treatment layer;
(d) an image forming station at which droplets of an ink are applied to an at least partially dried layer, formed on the ITM of the wet treatment layer, to form an ink image;
(e) a drying station for drying the ink image to leave an ink residue film; and
(f) an impression station at which the residue film is transferred to a sheet or web substrate sheet.

109. The printing system of embodiment 108, further comprising a controller adapted to:
(a) receive a print job to be printed by the printing system, the print job having a required resolution;
(b) automatically select the second quantity of the liquid surfactant additive based on the required resolution of the print job; and
(c) cause the mixing element to mix the select second quantity of the liquid surfactant additive with the first quantity of the liquid hydrophilic treatment formulation.

110. The printing system of embodiment 108 or embodiment 109, wherein the treatment station comprises at least one nozzle disposed adjacent the ITM for applying the mixture to the surface of the ITM.

111. A printing system comprising:
(a) an intermediate transfer member (ITM) comprising an endless belt;
(b) at least one nozzle disposed adjacent the ITM for applying a mixture to the surface of the ITM to form thereon a wet treatment layer, the mixture comprising a first quantity of a liquid hydrophilic treatment formulation and a second quantity of a liquid surfactant additive, the second quantity being at most 2% of the first quantity;
(c) an image forming station at which droplets of an ink are applied to an at least partially dried form of the mixture layer on the ITM to form an ink image;
(d) a drying station for drying the ink image to leave an ink residue film; and
(e) an impression station at which the residue film is transferred to a sheet or web substrate sheet.

112. The printing system of any one of embodiments 108 to 111, wherein the first quantity of the liquid hydrophilic treatment formulation is a first given quantity.

113. The printing system of any one of embodiments 108 to 112, wherein a dry form of the hydrophilic treatment formulation is a non-cohesive form of a solid or semisolid material sweated with a non-volatile liquid oil.

114. The printing system of any one of embodiments 108 to 113, wherein the liquid hydrophilic treatment formulation is devoid of the liquid surfactant additive prior to forming the mixture.

115. The printing system of any one of embodiments 108 to 114, wherein a diameter of ink dots formed from the droplets of ink, when the droplets of ink have a given volume, is configurable by modifying the second quantity of the liquid surfactant additive, relative to a given first quantity of the liquid hydrophilic treatment formulation.

116. The printing system of any one of embodiments 108 to 115, wherein the second quantity is at most 2% by weight of the first quantity.

117. The printing system of any one of embodiments 108 to 115, wherein the second quantity is at most 1% by weight of the first quantity.

118. The printing system of any one of embodiments 108 to 115, wherein the second quantity is at most 0.5% by weight of the first quantity.

119. The printing system of any one of embodiments 108 to 115, wherein the second quantity is at most 0.25% by weight of the first quantity.

120. The printing system of any one of embodiments 108 to 119, wherein the second quantity is at least 0.05% by weight of the first quantity.

121. The printing system of any one of embodiments 108 to 119, wherein the second quantity is at least 0.1% by weight of the first quantity.

122. The printing system of any one of embodiments 108 to 115, wherein, in the mixture the liquid surfactant additive is in the range of 0.1% to 0.5% by weight of the mixture.

123. The printing system of any one of embodiments 108 to 122, wherein the first quantity is in the range of 250 kg to 300 kg.

124. The printing system of any one of embodiments 108 to 123, wherein the second quantity is in the range of 0.5 kg to 1.0 kg.

125. The printing system of any one of embodiments 108 to 124, wherein the hydrophilic treatment formulation comprises:
i. a liquid containing water, the liquid containing water making up between about 5% to about 97.5%, by weight, of the hydrophilic treatment formulation;
ii. at least one first non-ionic surfactant;
wherein the hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of the hydrophilic treatment formulation is a non-cohesive form of a solid or semisolid material sweated with a non-volatile liquid oil.

126. The printing system of any one of embodiments 108 to 125, wherein the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

127. The printing system of embodiment 125 or embodiment 126, wherein the hydrophilic treatment formulation has the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight.

128. The printing system of any one of embodiments 125 to 127, wherein the hydrophilic treatment formulation is devoid of a second water-soluble polymer, the second water-soluble polymer being different from the first water-soluble polymeric wetting agent and wherein the second water-soluble polymer is a cohesive substance and/or a cohesion inducing substance.

129. The printing system of embodiment 128, wherein the second water-soluble polymer is a water absorbing polymeric agent.

130. The printing system of embodiment 128, wherein the hydrophilic treatment formulation is substantially devoid of a further cohesive substance and/or a cohesion inducing substance.

131. The printing system of embodiment 128, wherein the mixture is devoid of a further cohesive substance and/or a cohesion inducing substance.

132. The printing system of any one of embodiments 108 to 131, wherein the hydrophilic treatment formulation is substantially devoid of a film forming agent.

133. The printing system of any one of embodiments 108 to 131, wherein the mixture is substantially devoid of a film forming agent.

134. The printing system of any one of embodiments 125 to 133, wherein the liquid containing water is water only or a mixture of water and at least one water soluble organic solvent.

135. The printing system of any one of embodiments 125 to 134, wherein the hydrophilic treatment formulation further comprises at least one first water-soluble polymeric wetting agent.

136. The printing system of any one of embodiments 125 to 135, wherein the first water-soluble polymeric wetting agent is a multiple charged polymer e.g., a polycation or a polyanion.

137. The printing system of embodiment 136, wherein the polycation is selected from the group consisting of polyethyleneimine (PEI), poly(amidoamine) (PAMAM), poly-l-lysine (PLL) and poly(diallyl dimethyl ammonium) (PDDA).

138. The printing system of embodiment 136, wherein the polyanion is selected from the group consisting of acrylic polymers, polyacryl amides and poly-DADMAc.

139. The printing system of embodiment 136, wherein the first water-soluble polymeric wetting agent is PEI.

140. The printing system of any one of embodiments 136 to 139, wherein apart from the first water-soluble polymeric wetting agent and/or the at least one first non-ionic surfactant, the hydrophilic treatment formulation is devoid of a substance with a molecular weight being of about 1300 gr/mol and above.

141. The printing system of any one of embodiments 125 to 140, wherein the hydrophilic treatment formulation is further devoid of one or more of an inorganic salt, an inorganic metallic compound, a polyvalent metal ion and a metal ion.

142. The printing system of any one of embodiments 125 to 141, wherein the hydrophilic treatment formulation is further devoid of an acid.

143. The printing system of any one of embodiments 125 to 142, wherein the hydrophilic treatment formulation is further devoid of a resolubilizing agent.

144. The printing system of any one of embodiments 125 to 143, wherein the total percent solids by weight of the hydrophilic treatment formulation is at least about 5%, or between about 5% to about 95%, in particular between about 27% to about 95%, even more particular between about 35% to about 95%.

145. The printing system of any one of embodiments 125 to 144, wherein the hydrophilic treatment formulation has a 60° C. evaporation load of at least about 1.86:1 by weight.

146. The printing system of any one of embodiments 125 to 145, wherein the at least one first non-ionic surfactant has a solubility in water of at least about 7%, at 25° C.

147. The printing system of any one of embodiments 125 to 146, wherein the at least one first non-ionic surfactant makes up between about 2.5% to about 95%, by weight, of the hydrophilic treatment formulation.

148. The printing system of any one of embodiments 125 to 146, wherein the hydrophilic treatment formulation comprises at least two first non-ionic surfactants or at least three first non-ionic surfactants, and wherein a total content of the at least two or at least three first non-ionic surfactants make up between about 2.5% to about 95%, by weight, of the hydrophilic treatment formulation.

149. The printing system of any one of embodiments 125 to 148, wherein the at least one first non-ionic surfactant is a silicon containing surfactant.

150. The printing system of any one of embodiments 125 to 148, wherein the at least one first non-ionic surfactant is a non-silicon containing surfactant.

151. The printing system of any one of embodiments 125 to 145, wherein one or more of the first non-ionic surfactants is a non-silicon containing surfactant.

152. The printing system of any one of embodiments 125 to 151, wherein the at least one second non-ionic surfactant has a solubility in water of at least 1%, at 25° C.

153. The printing system of any one of embodiments 125 to 152, wherein the at least one second non-ionic surfactant is a silicon containing surfactant.

154. The printing system of any one of embodiments 125 to 152, wherein the at least one second non-ionic surfactant is a non-silicon containing surfactant.

155. The printing system of any one of embodiments 125 to 154, wherein the second non-ionic surfactant making up at most 10%, by weight of the hydrophilic treatment formulation.

156. The printing system of any one of embodiments 125 to 155, wherein the hydrophilic treatment formulation comprises at least two second non-ionic surfactants or at least three second non-ionic surfactants, and wherein a total content of the at least two or at least three second non-ionic surfactants make up at most 10%, by weight of the hydrophilic treatment formulation.

157. The printing system of any one of embodiments 125 to 156, wherein one or more of the second non-ionic surfactants is a non-silicon containing surfactant.

158. The printing system of any one of embodiments 125 to 157, wherein the hydrophilic treatment formulation further comprises at least one wetting agent, the wetting agent making up at most about 1%, by weight, of the hydrophilic treatment formulation, in particular at most about 0.20%, more particular 0.20% of the hydrophilic treatment formulation.

159. The printing system of any one of embodiments 125 to 158, wherein the humectant making up at most about 30%, by weight, of the hydrophilic treatment formulation.

160. The printing system of any one of embodiments 125 to 159, wherein the at least one humectant is a non-polymeric humectant.

161. The printing system of any one of embodiments 125 to 160, wherein the antibacterial agent making up at most about 1%, by weight, of the hydrophilic treatment formulation.

162. The printing system of any one of embodiments 125 to 161, wherein:
the at least one first non-ionic surfactant making up between about 2.5% to about 95%, by weight, of the hydrophilic treatment formulation;
the at least one second non-ionic surfactant making up at most 10%, by weight of the hydrophilic treatment formulation;
the at least one wetting agent making up at most about 1%, by weight, of the hydrophilic treatment formulation, in particular at most about 0.20%, more particular 0.20% of the hydrophilic treatment formulation;
the at least one humectant making up at most about 30%, by weight, of the hydrophilic treatment formulation; and
the at least one antibacterial agent making up at most about 1%, by weight, of the hydrophilic treatment formulation.

163. The printing system of any one of embodiments 125 to 162, wherein the hydrophilic treatment formulation is devoid of a silicon surfactant.

164. The printing system of any one of embodiments 125 to 163, wherein the ingredients of the hydrophilic treatment formulation are compatible with each other and with the liquid containing water.

165. The printing system of any one of embodiments 125 to 164, wherein the hydrophilic treatment formulation is a stable solution with no phase separation and with no sedimentation/precipitation at 25° C.

166. The printing system of any one of embodiments 125 to 165 wherein the hydrophilic treatment formulation is a clear colorless solution at 25° C.

167. The printing system of any one of embodiments 125 to 166, wherein the ingredients of the hydrophilic treatment formulation do not form aggregates with the colorant of an aqueous ink utilized in a printing system or method.

168. The printing system of any one of embodiments 108 to 167, wherein the liquid surfactant additive is a silicone-based surfactant.

169. The printing system of any one of embodiments 108 to 167, wherein the liquid surfactant additive is a non-silicone-based surfactant.

170. A method comprising:
(a) obtaining a kit comprising a liquid hydrophilic treatment formulation and a liquid surfactant additive disposed, separate from each other;
(b) at a first time, forming a first mixture by mixing a given volume of the liquid hydrophilic treatment formulation with a first volume of the liquid surfactant additive;
(c) at the first time, applying the first mixture onto the surface of an intermediate transfer member (ITM) of a printing system;
(d) at the first time, printing a first image onto the ITM having the first mixture applied thereon, by jetting droplets of an aqueous ink onto the ITM from at least one nozzle, the droplets having a given volume, to obtain first printed dots having a first diameter;
(e) at a second time, forming a second mixture by mixing the given volume of the liquid hydrophilic treatment formulation with a second volume of the liquid surfactant additive, the second volume being larger than the first volume;
(f) at the second time, applying the second mixture onto the surface of the ITM of the printing system;
(g) at the second time, printing a second image onto the ITM having the second mixture applied thereon, by jetting droplets of the aqueous ink onto the ITM from the at least one nozzle, the droplets having the given volume, to obtain second printed dots having a second diameter, smaller than the first diameter.

171. The method of embodiment 170, wherein the first volume and the second volume are less than 2% of the predetermined volume.

172. The method of any one of embodiments 170 to 171, wherein applying the first mixture comprises jetting the first mixture onto the surface of the ITM.

173. The method of any one of embodiments 170 to 172, wherein applying the second mixture comprises jetting the second mixture onto the surface of the ITM.

174. The method of any one of embodiments 170 to 173, wherein the applying of the first mixture comprises applying the first mixture onto a release layer of the ITM to form thereon a wet treatment layer having a thickness of at most about 5.0 μm.

175. The method of any one of embodiments 170 to 174, wherein the applying of the first mixture comprises at least partially drying a wet treatment layer of the first mixture to thereby form a first at least partially dried non-cohesive sweating treatment layer on the ITM surface.

176. The method of embodiment 175, wherein the first at least partially dried non-cohesive sweating treatment layer has a thickness in the range of 20 nm to 500 nm.

177. The method of any one of embodiments 170 to 176, wherein the applying of the second mixture comprises applying the second mixture onto a release layer of the ITM to form thereon a wet treatment layer having a thickness of at most about 5.0 μm.

178. The method of any one of embodiments 170 to 177, wherein the applying of the second mixture comprises at least partially drying a wet treatment layer of the second mixture to thereby form a second at least partially dried non-cohesive sweating treatment layer on the ITM surface.

179. The method of embodiment 178, wherein the second at least partially dried non-cohesive sweating treatment layer has a thickness in the range of 20 nm to 500 nm.

180. The method of any one of embodiments 170 to 179, wherein the aqueous ink comprises at least one binder and at least one colorant.

181. The method of any one of embodiments 170 to 180, wherein the printing of the first image comprises drying the first printed dots to leave a first ink image residue on the surface of the ITM and transferring the first ink image residue onto a printing substrate by pressured contact between the ITM and the printing substrate.

182. The method of any one of embodiments 170 to 181, wherein the printing of the second image comprises drying the second printed dots to leave a second ink image residue on the surface of the ITM and transferring the second ink image residue onto a second printing substrate by pressured contact between the ITM and the second printing substrate.

183. The method of any one of embodiments 170 to 182, wherein the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

184. The method of any one of embodiments 170 to 183, wherein the first mixture and the second mixture are substantially devoid of a cohesive substance and/or a cohesion inducing substance thereby once the first mixture or the second mixture is at least partially dried on the release layer surface of the ITM it does not form a film layer thereon.

185. The method of any one of embodiments 170 to 184, further comprising at least partially drying the first mixture on the ITM, prior to the printing of the first image.

186. The method of any one of embodiments 170 to 185, further comprising at least partially drying the second mixture on the ITM, prior to the printing of the second image.

187. The method of embodiment 185 or embodiment 186, wherein the at least partially drying of the first mixture or of the second mixture is carried out at a temperature in the range of 90° C. to about 130° C., inclusive.

188. The method of any one of embodiments 170 to 187, further comprising mixing the given volume of the liquid hydrophilic treatment formulation with the first quantity of the liquid surfactant additive to form the first mixture.

189. The method of any one of embodiments 170 to 188, further comprising mixing the given volume of the liquid hydrophilic treatment formulation with the second quantity of the liquid surfactant additive to form the second mixture.

190. The method of any one of embodiments 170 to 189, further comprising selecting the first quantity of the liquid surfactant additive based on a required resolution of the first image being printed.

191. The method of any one of embodiments 170 to 190, further comprising selecting the second quantity of the liquid surfactant additive based on a required resolution of the second image being printed.

192. The method of embodiment 190 or embodiment 191, wherein the selecting comprises automatically selecting the first quantity or the second quantity.

193. The method of any one of embodiments 170 to 192, wherein a quantity of the liquid surfactant additive in each of the first volume and the second volume is at most 2% by weight of a quantity of the liquid hydrophilic treatment formulation in the given volume.

194. The method of any one of embodiments 170 to 192, wherein a quantity of the liquid surfactant additive in each of the first volume and the second volume is at most 1% by weight of a quantity of the liquid hydrophilic treatment formulation in the given volume.

195. The method of any one of embodiments 170 to 192, wherein a quantity of the liquid surfactant additive in each of the first volume and the second volume is at most 0.5% by weight of a quantity of the liquid hydrophilic treatment formulation in the given volume.

196. The method of any one of embodiments 170 to 192, wherein a quantity of the liquid surfactant additive in each of the first volume and the second volume is at most 0.25% by weight of a quantity of the liquid hydrophilic treatment formulation in the given volume.

197. The method of any one of embodiments 170 to 196, wherein a quantity of the liquid surfactant additive in each of the first volume and the second volume is at least 0.05% by weight of a quantity of the liquid hydrophilic treatment formulation in the given volume.

198. The method of any one of embodiments 170 to 196, wherein a quantity of the liquid surfactant additive in each of the first volume and the second volume is at least 0.1% by weight of a quantity of the liquid hydrophilic treatment formulation in the given volume.

199. The method of any one of embodiments 170 to 198, wherein, in each of the first and second mixtures, a quantity of the liquid surfactant additive is in the range of 0.1% to 0.5% by weight of the mixture.

200. The method of any one of embodiments 170 to 199, wherein the hydrophilic treatment formulation comprises:
i. a liquid containing water, the liquid containing water making up between about 5% to about 97.5%, by weight, of the hydrophilic treatment formulation;
ii. at least one first non-ionic surfactant;
wherein the hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of the hydrophilic treatment formulation is a non-cohesive form of a solid or semisolid material sweated with a non-volatile liquid oil.

201. The method of any one of embodiments 170 to 200, wherein the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

202. The method of embodiment 200 or embodiment 201, wherein the hydrophilic treatment formulation has the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight.

203. The method of any one of embodiments 200 to 202, wherein the hydrophilic treatment formulation is devoid of a second water-soluble polymer, the second water-soluble polymer being different from the first water-soluble polymeric wetting agent and wherein the second water-soluble polymer is a cohesive substance and/or a cohesion inducing substance.

204. The method of embodiment 203, wherein the second water-soluble polymer is a water absorbing polymeric agent.

205. The method of embodiment 203, wherein the hydrophilic treatment formulation is substantially devoid of a further cohesive substance and/or a cohesion inducing substance.

206. The method of embodiment 203, wherein the method is devoid of a further cohesive substance and/or a cohesion inducing substance.

207. The method of any one of embodiments 170 to 206, wherein the hydrophilic treatment formulation is substantially devoid of a film forming agent.

208. The method of any one of embodiments 200 to 207, wherein the liquid containing water is water only or a mixture of water and at least one water soluble organic solvent.

209. The method of any one of embodiments 200 to 208, wherein the hydrophilic treatment formulation further comprises at least one first water-soluble polymeric wetting agent.

210. The method of any one of embodiments 200 to 209, wherein the first water-soluble polymeric wetting agent is a multiple charged polymer e.g., a polycation or a polyanion.

211. The method of embodiment 210, wherein the polycation is selected from the group consisting of polyethyleneimine (PEI), poly(amidoamine) (PAMAM), poly-l-lysine (PLL) and poly(diallyl dimethyl ammonium) (PDDA).

212. The method of embodiment 210, wherein the polyanion is selected from the group consisting of acrylic polymers, polyacryl amides and poly-DADMAc.

213. The method of embodiment 210, wherein the first water-soluble polymeric wetting agent is PEI.

214. The method of any one of embodiments 210 to 213, wherein apart from the first water-soluble polymeric wetting agent and/or the at least one first non-ionic surfactant, the hydrophilic treatment formulation is devoid of a substance with a molecular weight being of about 1300 gr/mol and above.

215. The method of any one of embodiments 200 to 214, wherein the hydrophilic treatment formulation is further devoid of one or more of an inorganic salt, an inorganic metallic compound, a polyvalent metal ion and a metal ion.

216. The method of any one of embodiments 200 to 215, wherein the hydrophilic treatment formulation is further devoid of an acid.

217. The method of any one of embodiments 200 to 216, wherein the hydrophilic treatment formulation is further devoid of a resolubilizing agent.

218. The method of any one of embodiments 200 to 217, wherein the total percent solids by weight of the hydrophilic treatment formulation is at least about 5%, or between about 5% to about 95%, in particular between about 27% to about 95%, even more particular between about 35% to about 95%.

219. The method of any one of embodiments 200 to 218, wherein the hydrophilic treatment formulation has a 60° C. evaporation load of at least about 1.86:1 by weight.

220. The method of any one of embodiments 200 to 219, wherein the at least one first non-ionic surfactant has a solubility in water of at least about 7%, at 25° C.

221. The method of any one of embodiments 200 to 220, wherein the at least one first non-ionic surfactant makes up between about 2.5% to about 95%, by weight, of the hydrophilic treatment formulation.

222. The method of any one of embodiments 200 to 220, wherein the hydrophilic treatment formulation comprises at least two first non-ionic surfactants or at least three first non-ionic surfactants, and wherein a total content of the at least two or at least three first non-ionic surfactants make up between about 2.5% to about 95%, by weight, of the hydrophilic treatment formulation.

223. The method of any one of embodiments 200 to 222, wherein the at least one first non-ionic surfactant is a silicon containing surfactant.

224. The method of any one of embodiments 200 to 222, wherein the at least one first non-ionic surfactant is a non-silicon containing surfactant.

225. The method of any one of embodiments 200 to 219, wherein one or more of the first non-ionic surfactants is a non-silicon containing surfactant.

226. The method of any one of embodiments 200 to 225, wherein the at least one second non-ionic surfactant has a solubility in water of at least 1%, at 25° C.

227. The method of any one of embodiments 200 to 226, wherein the at least one second non-ionic surfactant is a silicon containing surfactant.

228. The method of any one of embodiments 200 to 226, wherein the at least one second non-ionic surfactant is a non-silicon containing surfactant.

229. The method of any one of embodiments 200 to 228, wherein the second non-ionic surfactant making up at most 10%, by weight of the hydrophilic treatment formulation.

230. The method of any one of embodiments 200 to 229, wherein the hydrophilic treatment formulation comprises at least two second non-ionic surfactants or at least three second non-ionic surfactants, and wherein a total content of the at least two or at least three second non-ionic surfactants make up at most 10%, by weight of the hydrophilic treatment formulation.

231. The method of any one of embodiments 200 to 230, wherein one or more of the second non-ionic surfactants is a non-silicon containing surfactant.

232. The method of any one of embodiments 200 to 231, wherein the hydrophilic treatment formulation further comprises at least one wetting agent, the wetting agent making up at most about 1%, by weight, of the hydrophilic treatment formulation, in particular at most about 0.20%, more particular 0.20% of the hydrophilic treatment formulation.

233. The method of any one of embodiments 200 to 232, wherein the humectant making up at most about 30%, by weight, of the hydrophilic treatment formulation.

234. The method of any one of embodiments 200 to 233, wherein the at least one humectant is a non-polymeric humectant.

235. The method of any one of embodiments 200 to 234, wherein the antibacterial agent making up at most about 1%, by weight, of the hydrophilic treatment formulation.

236. The method of any one of embodiments 200 to 235, wherein:
the at least one first non-ionic surfactant making up between about 2.5% to about 95%, by weight, of the hydrophilic treatment formulation;
the at least one second non-ionic surfactant making up at most 10%, by weight of the hydrophilic treatment formulation;
the at least one wetting agent making up at most about 1%, by weight, of the hydrophilic treatment formulation, in particular at most about 0.20%, more particular 0.20% of the hydrophilic treatment formulation;
the at least one humectant making up at most about 30%, by weight, of the hydrophilic treatment formulation; and
the at least one antibacterial agent making up at most about 1%, by weight, of the hydrophilic treatment formulation.

237. The method of any one of embodiments 200 to 236, wherein the hydrophilic treatment formulation is devoid of a silicon surfactant.

238. The method of any one of embodiments 200 to 237, wherein the ingredients of the hydrophilic treatment formulation are compatible with each other and with the liquid containing water.

239. The method of any one of embodiments 200 to 238, wherein the hydrophilic treatment formulation is a stable solution with no phase separation and with no sedimentation/precipitation at 25° C.

240. The method of any one of embodiments 200 to 239 wherein the hydrophilic treatment formulation is a clear colorless solution at 25° C.

241. The method of any one of embodiments 200 to 240, wherein the ingredients of the hydrophilic treatment formulation do not form aggregates with the colorant of an aqueous ink utilized in a printing system or method.

242. The method of any one of embodiments 170 to 241, wherein the liquid surfactant additive is a silicone-based surfactant.

243. The method of any one of embodiments 170 to 241, wherein the liquid surfactant additive is a non-silicone-based surfactant.

244. The method of any one of embodiments 170 to 243, wherein:
obtaining the kit comprises obtaining a first kit including a first container holding the given volume of the liquid hydrophilic treatment formulation and a second container holding the first volume of the liquid surfactant additive, and obtaining a second kit including a third container holding the give volume of the liquid hydrophilic treatment formulation and a fourth container holding the second volume of the liquid surfactant additive;
forming the first mixture comprises mixing the entire contents of the first container and the second container; and
forming the second mixture comprises mixing the entire contents of the third container and the fourth container.

245. A system comprising:
(a) a printing system comprising:
   i) an intermediate transfer member (ITM) comprising an endless belt;
   ii) a treatment station for applying a mixture, including a given quantity of a liquid hydrophilic treatment formulation and a second quantity of a liquid surfactant additive, to the surface of the ITM to form thereon a wet treatment layer;
   iii) an image forming station at which droplets of an ink are applied to an at least partially dried layer, formed on the ITM of the wet treatment layer, to form an ink image;
   iv) a drying station for drying the ink image to leave an ink residue film; and
   v) an impression station at which the residue film is transferred to a sheet or web substrate sheet;
(b) a first kit including a first container holding the given quantity of the liquid hydrophilic treatment formulation and a second container holding a first volume of the liquid surfactant additive, the first volume usable as the second quantity when printing a first printing job on the printing system; and
(c) a second kit including a third container holding the given quantity of the liquid hydrophilic treatment formulation and a fourth container holding a second volume of the liquid surfactant additive, usable as the second quantity when printing a second printing job on the printing system, the second volume being greater than the first volume.

246. A method comprising:
(a) obtaining a kit comprising a liquid hydrophilic treatment formulation and a liquid surfactant additive, separate from each other;
(b) applying onto a surface of a first intermediate transfer member (ITM) of a first printing system a first mixture including a given volume of the liquid hydrophilic treatment formulation and a first volume of the liquid surfactant additive;
(c) printing a first image onto the first ITM having the first mixture applied thereon, by jetting droplets of an aqueous ink onto the first ITM from at least one nozzle, the droplets having a given volume, to first obtain printed dots having a first diameter;
(d) applying onto a surface of a second intermediate transfer member (ITM) of a second printing system a second mixture including the given volume of the liquid hydrophilic treatment formulation and a second volume of the liquid surfactant additive, the second volume being larger than the first volume; and
(e) printing a second image onto the second ITM having the second mixture applied thereon, by jetting droplets of an aqueous ink onto the second ITM from at least one nozzle, the droplets having the given volume, to obtain second printed dots having a second diameter, smaller than the first diameter,
   wherein the first printing system and the second printing system are printing systems of the same type, and
   wherein the first ITM and the second ITM are ITMs of the same type.

1. A kit for use with an intermediate transfer member (ITM) of a printing system, the kit comprising:
a) a liquid hydrophilic treatment formulation disposed in a first container, wherein a dry form of said hydrophilic treatment formulation is a non-cohesive form of a solid or semisolid material sweated with a non-volatile liquid oil;
b) a liquid surfactant additive disposed in a second container, such that the liquid hydrophobic treatment formulation is separate from the liquid surfactant additive,
wherein the liquid hydrophilic treatment formulation is devoid of the liquid surfactant additive,
wherein application of an aqueous ink onto an at least partially dry form of the hydrophilic treatment formulation applied to the ITM forms ink dots having a first diameter,
wherein application of the aqueous ink onto at least partially dry form of a mixture of a first quantity of the hydrophilic treatment formulation and a second quantity of the surfactant additive, the second quantity being smaller than the first quantity, the mixture applied to the ITM, forms ink dots having a second diameter, smaller than the first diameter, and
wherein the second diameter is configurable by modification of a ratio between the first quantity of the liquid hydrophilic treatment formulation in the mixture and the second quantity of the liquid surfactant additive in the mixture.

2. A kit for use with an intermediate transfer member (ITM) of a printing system, the kit comprising:
a) a liquid hydrophilic treatment formulation disposed in a first container, wherein a dry form of said hydrophilic treatment formulation is a non-cohesive form of a solid or semisolid material sweated with a non-volatile liquid oil;
b) a liquid surfactant additive disposed in a second container, such that the liquid hydrophobic treatment formulation is separate from the liquid surfactant additive,
wherein the liquid hydrophilic treatment formulation is devoid of the liquid surfactant additive,
wherein a mixture of a first quantity of the hydrophilic treatment formulation and a second quantity of the surfactant additive, retains at least one of the following properties of the liquid hydrophilic treatment formulation in the first container:
solubility;
clarity;
color;
reactivity with an aqueous ink used for printing on the ITM of the printing system;
ability to be applied to the ITM;
drying properties;
ability to form an ink film following deposit of aqueous ink onto a layer of the mixture;
mechanical properties; and
ability to be covered with a coating layer.

3. The kit of claim 2, wherein the mixture is different, in at least one of the following properties, from the liquid hydrophilic treatment formulation in the first container:
surface tension;
wetting; and
surface energy.

4. The kit of claim 3, wherein the mixture has a lower surface tension than the liquid hydrophilic treatment formulation in the first container.

5. The kit of claim 3 or claim 4, wherein the mixture has a lower surface energy than the liquid hydrophilic treatment formulation in the first container.

6. The kit of any one of claims 3 to 5, wherein the mixture has a lower wetting property than the liquid hydrophilic treatment formulation in the first container.

7. The kit of any one of claims 2 to 6, wherein application of an aqueous ink onto an at least partially dry form of the hydrophilic treatment formulation, applied to the ITM, forms ink dots having a first diameter,
wherein application of the aqueous ink onto at least partially dry form of a mixture of a first quantity of the hydrophilic treatment formulation and a second quantity of the surfactant additive applied to the ITM, the second quantity being smaller than the first quantity, forms ink dots having a second diameter, smaller than the first diameter, and
wherein the second diameter is configurable by modification of a ratio between the first quantity of the liquid hydrophilic treatment formulation in the mixture and the second quantity of the liquid surfactant additive in the mixture.

8. The kit of any one of claims 1 to 7, wherein a volume of the first container is at least twice, at least three times, at least five times, or at least ten times as large as a volume of the second container.

9. The kit of any one of claims 1 to 8, wherein the second container comprises multiple second containers, each holding a different volume of the liquid surfactant additive, and wherein the second quantity is equal to the entire volume of one of said multiple second containers.

10. The kit of any one of claims 1 to 9, wherein the second quantity is at most 2% by weight of the first quantity.

11. The kit of any one of claims 1 to 10, wherein the second quantity is at least 0.05% by weight of the first quantity.

12. The kit of claim 1 or claim 7, wherein a range of the ratio of the first diameter to the second diameter is in the range of 1.05:1 to 4:1.

13. The kit of any one of claims 1 to 12, wherein the hydrophilic treatment formulation comprises:
i. a liquid containing water, said liquid containing water making up between about 5% to about 97.5%, by weight, of the hydrophilic treatment formulation;
ii. at least one first non-ionic surfactant;
wherein said hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of said hydrophilic treatment formulation is a non-cohesive form of a solid or semisolid material sweated with a non-volatile liquid oil.

14. The kit of any one of claims 1 to 13, wherein the liquid surfactant additive is a silicone-based surfactant.

15. The kit of any one of claims 1 to 13, wherein the liquid surfactant additive is a non-silicone-based surfactant.

16. A method of indirect printing using the kit of any one of claims 1 to 15, the method comprising:
a. providing an intermediate transfer member (ITM) comprising a release layer surface;
b. mixing the first quantity of the hydrophilic treatment formulation with the second quantity of the surfactant additive to form the mixture;
c. applying the mixture onto the release layer surface of the ITM to form thereon a wet treatment layer optionally having a thickness of at most about 5.0 μm;
d. at least partially drying said wet treatment layer to thereby form an at least partially dried non-cohesive sweating treatment layer from the wet treatment layer on the ITM release layer surface, said at least partially dried non-cohesive sweating treatment layer optionally having a thickness of at least about 20 nm and at most about 500 nm;
e. depositing droplets of an aqueous ink, onto at least a region of the at least partially dried non-cohesive sweating treatment layer, to form an ink image on the ITM release layer surface;
f. drying the ink image to leave an ink-image residue on the ITM release layer surface; and
g. transferring the ink-image residue onto a printing substrate by pressured contact between the ITM and the printing substrate.

17. The method of claim 16, wherein said mixture is substantially devoid of a cohesive substance and/or a cohesion inducing substance thereby once said mixture is at least partially dried on the release layer surface of the ITM it does not form a film layer thereon.

18. The method of claim 16 or claim 17, further comprising, prior to the mixing, selecting the second quantity of the liquid surfactant based on a required resolution of the print job being printed.

19. The method of claim 18, wherein the selecting comprises automatically selecting the second quantity based on the required resolution, and the mixing comprises automatically mixing the selected second quantity with the first quantity to form the mixture.

20. The method of any one of claims 16 to 19, wherein the applying of the mixture comprises jetting the mixture onto the release layer surface of the ITM.

21. A system for indirect printing using the kit of any one of claims 1 to 15, the system comprising:
a. an intermediate transfer member (ITM) comprising a release layer surface;
b. a mixture of the first quantity of the hydrophilic treatment formulation and the second quantity of the surfactant additive;
c. a treatment station for applying the mixture to the release layer surface of the ITM to form thereon a wet treatment layer optionally having a thickness of at most 5.0 μm;
d. means for subjecting the wet treatment layer to a drying process to form an at least partially dried non-cohesive sweating treatment layer from the wet treatment layer on the ITM release layer surface, said at least partially dried non-cohesive sweating treatment layer optionally having a thickness of at least about 20 nm and at most about 500 nm;
e. at least one ink jet nozzle positioned proximate the intermediate transfer member and configured for jetting aqueous ink droplets, onto at least a region of the at least partially dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

22. The system of claim 21, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

23. A printed article comprising:
(i) a substrate;
(ii) one or more dry ink dots fixedly adhered to at least a region of a surface of said substrate,
wherein said one or more dry ink dots comprise at least one binder, at least one colorant and one or more of non-volatile ingredients of the kit of any one of claims 1 to 15.

24. The printed article of claim 23, wherein said dry one or more ink dots are further covered with a dry non-cohesive sweating layer comprising one or more of the non-volatile ingredients of said kit.

25. The printed article of claim 23 or 24, wherein non printed regions of said substrate are covered with a dry non-cohesive sweating layer comprising one or more of the non-volatile ingredients of the kit.

26. An intermediate transfer member comprising a release layer surface, wherein said surface is substantially covered with a dry non-cohesive sweating layer comprising one or more of the non-volatile ingredients of the hydrophilic treatment formulation and the surfactant additive of the kit of any one of claims 1 to 15, and optionally wherein the thickness of said dry non-cohesive sweating layer being of at least about 20 nm and at most about 500 nm.

27. The intermediate transfer member of claim 26, wherein the dry non-cohesive sweating layer covers at least 50% or at least 75% or at least 90% or at least 95% at least 95% or at least 99% or 100% of the intermediate transfer member release layer surface.

28. An intermediate transfer member comprising a release layer surface, wherein said surface is substantially covered with a mixture of the first quantity of the hydrophilic treatment formulation and the second quantity of the surfactant additive of the kit of any one of claims 1 to 15.

29. An intermediate transfer member comprising a release layer surface, wherein said surface is substantially covered with a mixture of the first quantity of the hydrophilic treatment formulation and the second quantity of the surfactant additive of the kit of any one of claims 1 to 15, and wherein when said intermediate transfer member is at a temperature being of between about 90° C. to about 130° C., a dried non-cohesive sweating treatment layer is formed thereon, optionally wherein the thickness of said dry non-cohesive sweating layer being of at least about 20 nm and at most about 500 nm.

30. The intermediate transfer member of any one of claims 26 to 29, comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

31. A printing system comprising:
(a) an intermediate transfer member (ITM) comprising an endless belt;
(b) a mixing element adapted to form a mixture from a first quantity of a liquid hydrophilic treatment formulation and a second quantity of a liquid surfactant additive, the second quantity being at most 2% of the first quantity;
(c) a treatment station for applying the mixture to the surface of the ITM to form thereon a wet treatment layer;
(d) an image forming station at which droplets of an ink are applied to an at least partially dried layer, formed on the ITM of the wet treatment layer, to form an ink image;
(e) a drying station for drying the ink image to leave an ink residue film; and
(f) an impression station at which the residue film is transferred to a sheet or web substrate sheet.

32. The printing system of claim 31, further comprising a controller adapted to:
(a) receive a print job to be printed by the printing system, the print job having a required resolution;
(b) automatically select the second quantity of the liquid surfactant additive based on the required resolution of the print job; and
(c) cause the mixing element to mix the select second quantity of the liquid surfactant additive with the first quantity of the liquid hydrophilic treatment formulation.

33. The printing system of claim 31 or claim 32, wherein the treatment station comprises at least one nozzle disposed adjacent the ITM for applying the mixture to the surface of the ITM.

34. A printing system comprising:
(a) an intermediate transfer member (ITM) comprising an endless belt;
(b) at least one nozzle disposed adjacent the ITM for applying a mixture to the surface of the ITM to form thereon a wet treatment layer, the mixture comprising a first quantity of a liquid hydrophilic treatment formulation and a second quantity of a liquid surfactant additive, the second quantity being at most 2% of the first quantity;
(c) an image forming station at which droplets of an ink are applied to an at least partially dried form of the mixture layer on the ITM to form an ink image;
(d) a drying station for drying the ink image to leave an ink residue film; and
(e) an impression station at which the residue film is transferred to a sheet or web substrate sheet.

35. The printing system of any one of claims 31 to 34, wherein the liquid hydrophilic treatment formulation is devoid of the liquid surfactant additive prior to forming the mixture.

36. The printing system of any one of claims 31 to 35, wherein a diameter of ink dots formed from the droplets of ink, when the droplets of ink have a given volume, is configurable by modifying the second quantity of the liquid surfactant additive, relative to a given first quantity of the liquid hydrophilic treatment formulation.

37. The printing system of any one of claims 31 to 36, wherein the second quantity is at most 2% by weight of the first quantity.

38. The printing system of any one of claims 31 to 37, wherein the second quantity is at least 0.05% by weight of the first quantity.

39. The printing system of any one of claims 31 to 38, wherein the hydrophilic treatment formulation comprises:
i. a liquid containing water, said liquid containing water making up between about 5% to about 97.5%, by weight, of the hydrophilic treatment formulation;
ii. at least one first non-ionic surfactant;
wherein said hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of said hydrophilic treatment formulation is a non-cohesive form of a solid or semisolid material sweated with a non-volatile liquid oil.

40. The printing system of any one of claims 31 to 39, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

41. The printing system of any one of claims 31 to 40, wherein the liquid surfactant additive is a silicone-based surfactant.

42. The printing system of any one of claims 31 to 40, wherein the liquid surfactant additive is a non-silicone-based surfactant.

43. A method comprising:
(a) obtaining a kit comprising a liquid hydrophilic treatment formulation and a liquid surfactant additive disposed, separate from each other;
(b) at a first time, forming a first mixture by mixing a given volume of the liquid hydrophilic treatment formulation with a first volume of the liquid surfactant additive;
(c) at the first time, applying the first mixture onto the surface of an intermediate transfer member (ITM) of a printing system;
(d) at the first time, printing a first image onto the ITM having the first mixture applied thereon, by jetting droplets of an aqueous ink onto the ITM from at least one nozzle, the droplets having a given volume, to obtain first printed dots having a first diameter;
(e) at a second time, forming a second mixture by mixing the given volume of the liquid hydrophilic treatment formulation with a second volume of the liquid surfactant additive, the second volume being larger than the first volume;
(f) at the second time, applying the second mixture onto the surface of the ITM of the printing system;
(g) at the second time, printing a second image onto the ITM having the second mixture applied thereon, by jetting droplets of the aqueous ink onto the ITM from the at least one nozzle, the droplets having the given volume, to obtain second printed dots having a second diameter, smaller than the first diameter.

44. The method of claim 43, wherein the first volume and the second volume are less than 2% of the predetermined volume.

45. The method of any one of claims 43 to 44, wherein applying the first mixture comprises jetting the first mixture onto the surface of the ITM.

46. The method of any one of claims 43 to 45, wherein applying the second mixture comprises jetting the second mixture onto the surface of the ITM.

47. The method of any one of claims 43 to 46, wherein the printing of the first image comprises drying the first printed dots to leave a first ink image residue on the surface of the ITM and transferring the first ink image residue onto a printing substrate by pressured contact between the ITM and the printing substrate.

48. The method of any one of claims 43 to 47, wherein the printing of the second image comprises drying the second printed dots to leave a second ink image residue on the surface of the ITM and transferring the second ink image residue onto a second printing substrate by pressured contact between the ITM and the second printing substrate.

49. The method of any one of claims 43 to 48, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

50. The method of any one of claims 43 to 49, wherein said first mixture and said second mixture are substantially devoid of a cohesive substance and/or a cohesion inducing substance thereby once said first mixture or said second mixture is at least partially dried on the release layer surface of the ITM it does not form a film layer thereon.

51. The method of any one of claims 43 to 50, further comprising at least partially drying the first mixture on the ITM, prior to the printing of the first image.

52. The method of any one of claims 43 to 51, further comprising at least partially drying the second mixture on the ITM, prior to the printing of the second image.

53. The method of any one of claims 43 to 52, further comprising mixing the given volume of the liquid hydrophilic treatment formulation with the first quantity of the liquid surfactant additive to form the first mixture.

54. The method of any one of claims 43 to 53, further comprising mixing the given volume of the liquid hydrophilic treatment formulation with the second quantity of the liquid surfactant additive to form the second mixture.

55. The method of any one of claims 43 to 54, further comprising selecting the first quantity of the liquid surfactant additive based on a required resolution of the first image being printed.

56. The method of any one of claims 43 to 55, further comprising selecting the second quantity of the liquid surfactant additive based on a required resolution of the second image being printed.

57. The method of claim 55 or claim 56, wherein the selecting comprises automatically selecting the first quantity or the second quantity.

58. The method of any one of claims 43 to 57, wherein a quantity of the liquid surfactant additive in each of the first volume and the second volume is at most 2% by weight of a quantity of the liquid hydrophilic treatment formulation in the given volume.

59. The method of any one of claims 43 to 58, wherein a quantity of the liquid surfactant additive in each of the first volume and the second volume is at least 0.05% by weight of a quantity of the liquid hydrophilic treatment formulation in the given volume.

60. The method of any one of claims 43 to 59, wherein the hydrophilic treatment formulation comprises:
i. a liquid containing water, said liquid containing water making up between about 5% to about 97.5%, by weight, of the hydrophilic treatment formulation;
ii. at least one first non-ionic surfactant;
wherein said hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of said hydrophilic treatment formulation is a non-cohesive form of a solid or semisolid material sweated with a non-volatile liquid oil.

61. The method of any one of claims 43 to 60, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

62. The method of any one of claims 43 to 61, wherein the liquid surfactant additive is a silicone-based surfactant.

63. The method of any one of claims 43 to 61, wherein the liquid surfactant additive is a non-silicone-based surfactant.

64. The method of any one of claims 43 to 63, wherein:
obtaining the kit comprises obtaining a first kit including a first container holding the given volume of the liquid hydrophilic treatment formulation and a second container holding the first volume of the liquid surfactant additive, and obtaining a second kit including a third container holding the give volume of the liquid hydrophilic treatment formulation and a fourth container holding the second volume of the liquid surfactant additive;
forming the first mixture comprises mixing the entire contents of the first container and the second container; and
forming the second mixture comprises mixing the entire contents of the third container and the fourth container.

65. A system comprising:
(a) a printing system comprising:
i) an intermediate transfer member (ITM) comprising an endless belt;
ii) a treatment station for applying a mixture, including a given quantity of a liquid hydrophilic treatment formulation and a second quantity of a liquid surfactant additive, to the surface of the ITM to form thereon a wet treatment layer;
iii) an image forming station at which droplets of an ink are applied to an at least partially dried layer, formed on the ITM of the wet treatment layer, to form an ink image;
iv) a drying station for drying the ink image to leave an ink residue film; and
v) an impression station at which the residue film is transferred to a sheet or web substrate sheet;
(b) a first kit including a first container holding the given quantity of the liquid hydrophilic treatment formulation and a second container holding a first volume of the liquid surfactant additive, the first volume usable as the second quantity when printing a first printing job on the printing system; and
(c) a second kit including a third container holding the given quantity of the liquid hydrophilic treatment formulation and a fourth container holding a second volume of the liquid surfactant additive, usable as the second quantity when printing a second printing job on the printing system, the second volume being greater than the first volume.
